(19) United States
(12) Patent Application Publication
(10) Pub. No.: US 2026/0253141 A1
(43) Pub. Date: Aug. 27, 2026

(54) One-Click Submission in a Binding Policy Platform Network

(71) Applicant: Shahab Safari, Woodland Hills, CA (US)

(72) Inventor: Shahab Safari, Woodland Hills, CA (US)

(21) Appl. No.: 19/060,946

(22) Filed: Feb. 24, 2025

(51) Int. Cl. G06Q 40/08; G06N 20/00

(52) U.S. Cl. CPC G06Q 40/08; G06N 20/00

(57) ABSTRACT

A method for execution by one or more platform computing devices of a binding policy platform (BPP) network includes receiving a quote request regarding a policy from an agent computing device, wherein the quote request includes application data associated with the policy and a client. The method further includes determining a plurality of entity pairs of the BPP network, wherein each entity pair includes the agent computing device and a corresponding other computing device of a group of computing devices. The method further includes generating a plurality of application data sets based on a modification of at least one data point of the application data, and an insurer-specific requirement of a plurality of insurer-specific requirements. The method further includes sending the plurality of application data sets to the group of computing devices to solicit a plurality of quote replies for the quote request.

### CROSS-REFERENCE TO RELATED APPLICATIONS

Not Applicable. cl STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to communication networks and more particularly to data storage and operation within a binding policy platform network.

### Description of Related Art

In the insurance industry, the process of obtaining and comparing quotes from multiple insurers can be complex and time-consuming. Traditionally, agents have had to manually input client data into various insurer systems, each with its own specific data format and requirements. This manual process not only increases the likelihood of errors but also delays the time it takes to receive and compare quotes. Additionally, the selection of insurers to solicit quotes from often relies on the agent's personal knowledge and relationships, which may not always result in the most competitive or suitable options for the client.

### BRIEF DESCRIPTION OF THE SEVERAL VIEWS OF THE DRAWING(S)

FIG. 1 is a schematic block diagram of an embodiment of a binding policy platform network accordance with various embodiments;

FIGS. 2-5 are a schematic block diagrams of various embodiments of a computing device in accordance with various embodiments;

FIG. 6 is a schematic block diagram of an embodiment of ingesting insurer guideline data in a BPP network in accordance with various embodiments;

FIG. 7 is a schematic block diagram of an embodiment of a data table of insurer guideline data in accordance with various embodiments;

FIG. 8 is a schematic block diagram of another embodiment of a data table of insurer guideline data in accordance with various embodiments;

FIG. 9 is a schematic block diagram of an embodiment of ingesting agency information in a BPP network in accordance with various embodiments;

FIG. 10 is a schematic block diagram of an embodiment of ingesting managing general agent information in a BPP network in accordance with various embodiments;

FIG. 11 is a schematic block diagram of an embodiment of ingesting client information in a BPP network in accordance with various embodiments;

FIG. 12 is a schematic block diagram of an embodiment of a BPP database of a BPP network in accordance with various embodiments;

FIG. 13 is a schematic block diagram of an embodiment of entity pairing in a BPP network in accordance with various embodiments;

FIG. 14 is a schematic block diagram of another embodiment of entity pairing in a BPP network in accordance with various embodiments;

FIG. 15 is a schematic block diagram of an embodiment of determining required quote information in a BPP network in accordance with various embodiments;

FIG. 16 is a schematic block diagram of an embodiment of generating unified application fields in a BPP network in accordance with various embodiments;

FIG. 17 is a schematic block diagram of an embodiment of populating application data sets in a BPP network in accordance with various embodiments;

FIG. 18 is a schematic block diagram of an embodiment of filtering entities in a BPP network in accordance with various embodiments;

FIG. 19 is a schematic block diagram of another embodiment of filtering entities in a BPP network in accordance with various embodiments;

FIG. 20 is a schematic block diagram of another embodiment of filtering entities in a BPP network in accordance with various embodiments;

FIG. 21 is a schematic block diagram of another embodiment of filtering entities in a BPP network in accordance with various embodiments;

FIG. 22 is a schematic block diagram of another embodiment of filtering entities in a BPP network in accordance with various embodiments;

FIG. 23 is a schematic block diagram of an embodiment of determining market access gateway program participants in a BPP network in accordance with various embodiments;

FIG. 24 is a schematic block diagram of an embodiment of market access gateway connections in a BPP network in accordance with various embodiments;

FIG. 25 is a schematic block diagram of an embodiment of entity portals in a BPP network in accordance with various embodiments;

FIG. 26 is a schematic block diagram of another embodiment of entity portals in a BPP network in accordance with various embodiments;

FIG. 27 is a logic diagram illustrating a method for execution in accordance with various embodiments;

FIG. 28 is a logic diagram illustrating another method for execution in accordance with various embodiments;

FIG. 29 is a logic diagram illustrating another method for execution in accordance with various embodiments;

FIG. 30 is a logic diagram illustrating another method for execution in accordance with various embodiments;

FIG. 31 is a logic diagram illustrating another method for execution in accordance with various embodiments;

FIG. 32 is a logic diagram illustrating another method for execution in accordance with various embodiments;

FIG. 33 is a logic diagram illustrating another method for execution in accordance with various embodiments; and

FIG. 34 is a logic diagram illustrating another method for execution in accordance with various embodiments.

### DETAILED DESCRIPTION OF THE INVENTION

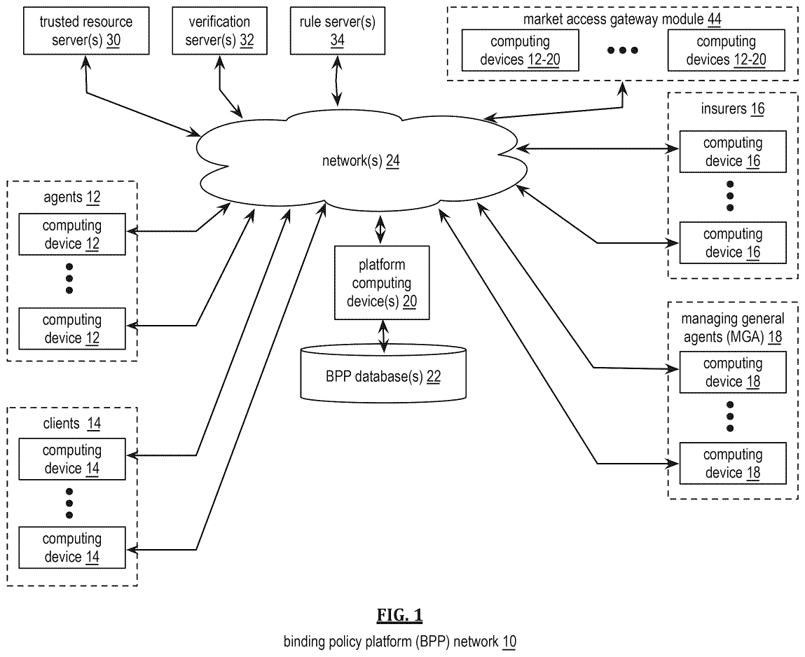

FIG. 1 is a schematic block diagram of an embodiment of a binding policy platform (BPP) network that includes computing devices 12 of agents, computing devices 14 of clients, computing devices 16 of insurers, computing devices 18 of managing general agents (MGAs), a market access gateway module 44, one or more platform computing devices 20, one or more BPP databases 22, one or more networks 24, one or more trusted resources servers 30, one or more verification servers 32, and one or more rule servers 34. Hereinafter, the BPP network may be interchangeably reference as a platform network, a system, a communication system, a data communication system, and a communication network. The one or more platform computing devices process, and the one or more BPP databases store, binding policy information associated with a policy of an insurer.

In general, a computing device is any electronic device that can communicate data, process data, and/or store data. Further in general, a computing device includes one or more central processing units (CPUs), one or more graphical processing units (GPUs), a memory system, user input/output interfaces, peripheral device interfaces, and an interconnecting bus structure. In an example, the term, a computing device, indicates that at least one computing device is involved in processing, transmitting, receiving and/or storing data. For example, a computing device may receive and store information in internal memory of the computing device. As another example, a computing device may execute an instruction in combination with other computing devices to produce a result. The result can include one or more sub-results aggregated in parallel to produce the result. In an example, the processing is performed via cloud computing and/or in parallel with other computing devices. Such examples include processing that cannot be practically performed in the human mind and/or by a human with a pen and paper. For example, while it may be possible for a human to perform a calculation by pen and paper, that would take days, months or years to complete, a computing device may perform the calculation in seconds or less (e.g., milliseconds, microseconds, nanoseconds, etc.).

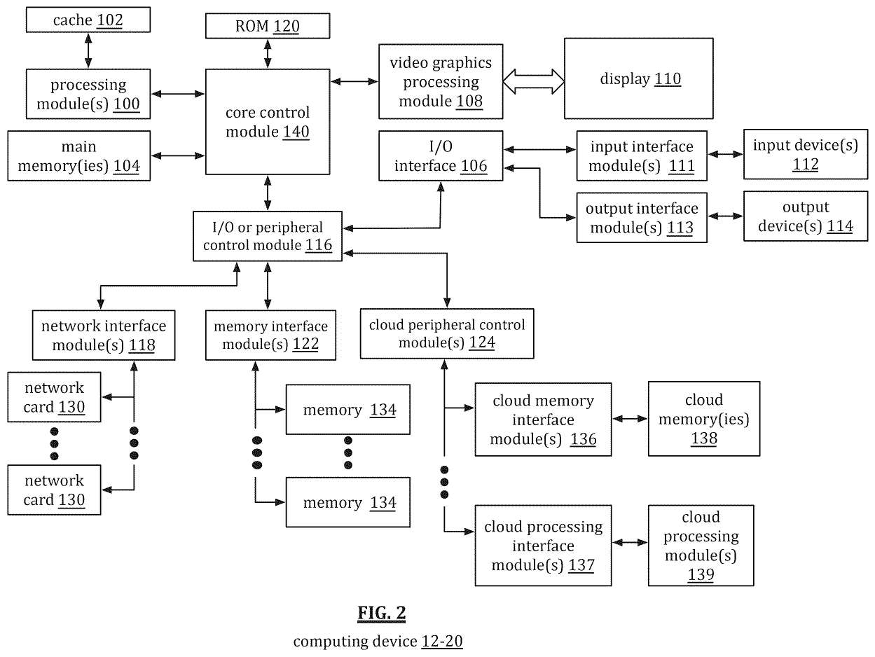

A computing device 12-20 may function as a user computing device, a server, a data storage device, a data security device, a cryptocurrency mining device, a networking device, a system computing device, a user access device, a cell phone, a tablet, a laptop, a printer, a gaming console, a satellite control box, etc. Some examples of computing devices 12-20 are discussed in greater detail with reference to FIGS. 2A-2D.

The binding policy platform (BPP) network functions to increase accuracy, decrease latency, and decrease bandwidth requirements in one or more of processing quote requests, matching one or more entities (e.g., clients, brokers, agents, MGAs, underwriters, and insurers) with one another, discovering one or more entities, and facilitating the process of one or more of discovering, quoting, modifying, and binding of insurance policies, contracts and/or other services between two or more of the entities.

An example of a trusted resource server is a Safety and Fitness Electronic Records (SAFER) system server, which is managed by the Federal Motor Carrier Safety Administration (FMCSA). The trusted resource server may provide external information regarding safety data for companies and vehicles associated with binding a policy in the BPP network 10. The safety data includes one or more of company snapshots, safety ratings, roadside out-of-service inspection summaries and crash information for motor carriers.

An example of a verification server is a department of motor vehicles (DMV) server, which includes vehicle data such as vehicle registrations, driver's licenses, traffic violations, and accidents within its jurisdiction (e.g., State).

An example of a rule server is a National Association of Insurance Commissioners (NAIC) server that includes data such as System for Electronic Rate and Form Filing (SERFF) and model acts and regulations that standardizes how insurance products are coded.

The market access gateway module 44 functions to allow entities that are not currently matched, do not have access to one another, or alternatively do not know that each other exists, to interact to facilitate one or more of matching, quoting and binding of insurance services (policies, contracts, etc.). In an example, matching includes facilitating an appointment between an agent or a broker and an insurance company. For example, an agent computing device can submit a quote for an insurance policy via the market access gateway module 44, which can allow access of at least a portion of the quote (risk profile, policy details, etc.) to a plurality of MGA and insurer computing devices of an open market (MGAs, insurers, etc., whom the agent does not have an appointment with), who then have the opportunity to submit a quote reply if they desire.

In some examples, the market access gateway module 44 is accessible from a computing device 12-18 via an application supported by (e.g., one or more of downloaded from, at least partially running on, receiving updates from, etc.) the one or more platform computing devices 20. In some example, the market access gateway module 44 functions to display one or more windows on a user interface on a display (e.g., touch screen display, monitor, LED display, etc.) of a computing device 12-20, detect one or more gestures, selections, or other inputs (e.g., mouse click, keyboard shortcut, etc.) for interacting with elements of the one or more windows.

FIG. 2 is a schematic block diagram of an embodiment of a computing device 12-20 that includes a plurality of computing resources. The computing resources, which form a computing core, include one or more core control modules 140, one or more processing modules 100, one or more main memories 104, a read only memory (ROM) 120 for a boot up sequence, cache memory 102, one or more video graphics processing modules 108, one or more displays 110 (optional), an Input-Output (I/O) peripheral control module 116, an I/O interface module 106 (which could be omitted if direct connect IO is implemented), one or more input interface modules 111, one or more output interface modules 113, one or more network interface modules 118, one or more memory interface modules 122, and one or more cloud peripheral control modules 124.

A processing module 100 is described in greater detail at the end of the detailed description section and, in an alternative embodiment, has a direction connection to the main memory 104. In an alternate embodiment, the core control module 140 and the I/O interface 106 and/or peripheral control module 116 are one module, such as a chipset, a quick path interconnect (QPI), and/or an ultra-path interconnect (UPI).

The processing module 100, the core control module 140, and/or the video graphics processing module 108 form a processing core for an improved computer. Additional combinations of processing modules 100, core modules 140, and/or video graphics processing modules 140 form co-processors for the improved computer for technology.

Each of the main memories 104 includes one or more Random Access Memory (RAM) integrated circuits, or chips. In general, the main memory 104 stores data and operational instructions most relevant for the processing module 100. For example, the core control module 140 coordinates the transfer of data and/or operational instructions between the main memory 104 and the memory device(s) 134. The data and/or operational instructions retrieve from memory 134 are the data and/or operational instructions requested by the processing module or will most likely be needed by the processing module. When the processing module is done with the data and/or operational instructions in main memory 104, the core control module 140 coordinates sending updated data to the memory 134 for storage.

The memory 134 includes one or more hard drives, one or more solid state memory chips, and/or one or more other large capacity storage devices that, in comparison to cache memory and main memory devices, is/are relatively inexpensive with respect to cost per amount of data stored. The secondary memory 134 is coupled to the core control module 140 via the I/O and/or peripheral control module 116 and via one or more memory interface modules 122. In an embodiment, the I/O and/or peripheral control module 116 includes one or more Peripheral Component Interface (PCI) buses to which peripheral components connect to the core control module 140. A memory interface module 122 includes a software driver and a hardware connector for coupling a memory device 134 to the I/O and/or peripheral control module 116. For example, a memory interface module 122 is in accordance with a Serial Advanced Technology Attachment (SATA) port.

The core control module 140 coordinates data communications between the processing module(s) 100 and network(s) via the I/O and/or peripheral control module 116, the network interface module(s) 118, and one or more network cards 130. A network card 130 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 118 includes a software driver and a hardware connector for coupling the network card 130 to the I/O and/or peripheral control module 116. For example, the network interface module 118 is in accordance with one or more versions of 10/100/1000 Gigabit LAN protocols, IEEE 802.11, cellular telephone protocols, etc.

The core control module 140 coordinates data communications between the processing module(s) 100 and input device(s) 112 via the input interface module(s) 111, the I/O interface 106, and the I/O and/or peripheral control module 116. An input device 112 includes a touchpad, a microphone, a keypad, a keyboard, control switches, a camera, etc. An input interface module 111 includes a software driver and a hardware connector for coupling an input device 112 to the I/O and/or peripheral control module 116. In an embodiment, an input interface module 111 is in accordance with one or more Universal Serial Bus (USB) protocols.

The core control module 140 coordinates data communications between the processing module(s) 100 and of one or more cloud modules 138-139 via one or more cloud peripheral control module(s) 124, and the I/O and/or peripheral control module 116. A cloud module includes one or more cloud memory interface modules 136, one or more cloud processing interface modules 137, cloud memory 138, and one or more cloud processing modules 139. The cloud memory 138 includes one or more tiers of memory (e.g., ROM, volatile (RAM, main, etc.), non-volatile (hard drive, solid-state, etc.) and/or backup (hard drive, tape, etc.)) that is remote from the core control module and is accessed via a network (WAN and/or LAN). The cloud processing module(s) 139 are similar to processing module(s) 100 but is remote from the core control module(s) 140 and is accessed via a network.

The core control module 140 coordinates data communications between the processing module(s) 100 and output device(s) 114 via the output interface module(s) 113 and the I/O and/or peripheral control module 116. An output device 114 includes a speaker, auxiliary memory, headphones, etc. An output interface module 113 includes a software driver and a hardware connector for coupling an output device 114 to the I/O and/or peripheral control module 116. In an embodiment, an output interface module 113 is in accordance with one or more audio codec protocols.

The processing module 100 communicates directly with a video graphics processing module 108 to display data on the display 110. The display 110 includes an LED (light emitting diode) display, an LCD (liquid crystal display), and/or other type of display technology. The display has a resolution, an aspect ratio, and other features that affect the quality of the display. The video graphics processing module 108 receives data from the processing module 100, processes the data to produce rendered data in accordance with the characteristics of the display, and provides the rendered data to the display 110.

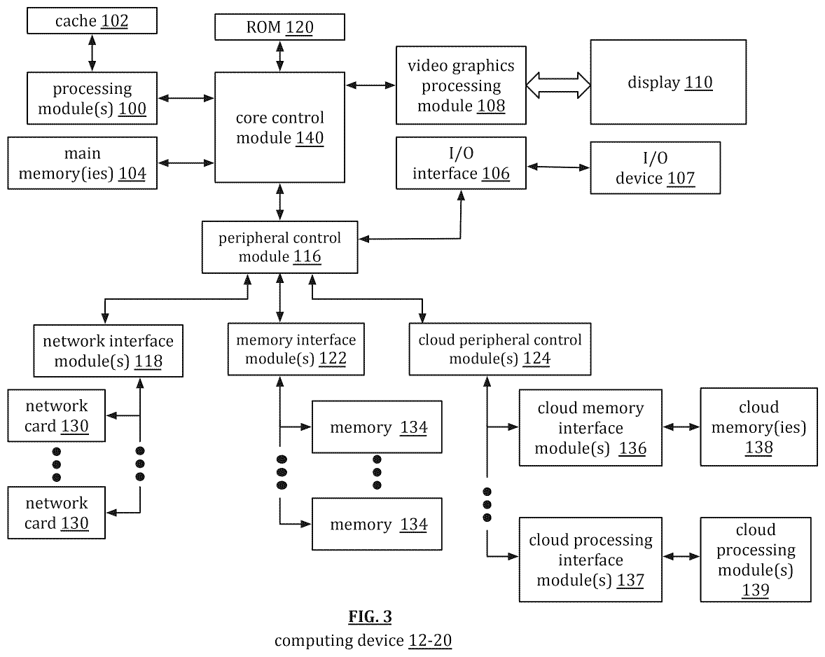

FIG. 3 is a schematic block diagram of an embodiment of a computing device 12-20 that is similar to the computing device of FIG. 2A with a change in the input output devices and their associated I/O interfaces.

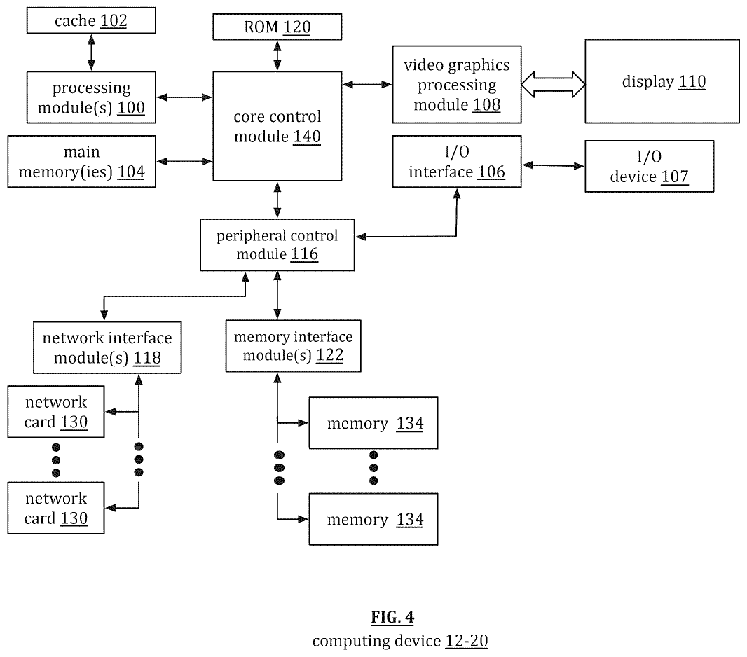

FIG. 4 is a schematic block diagram of an embodiment of a computing device 12-20 that is similar to the computing device of FIG. 2A with one change being omission of one or more of the cloud devices.

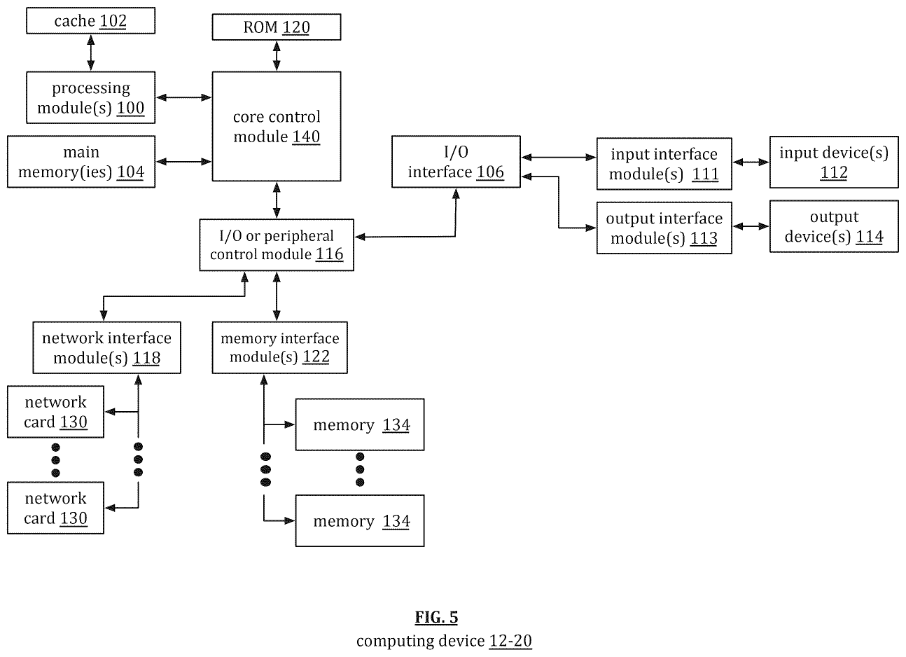

FIG. 5 is a schematic block diagram of an embodiment of a computing device 12-20 that is similar to the computing device of FIG. 2C with one change being omission the video graphics processing module 48 and display 50.

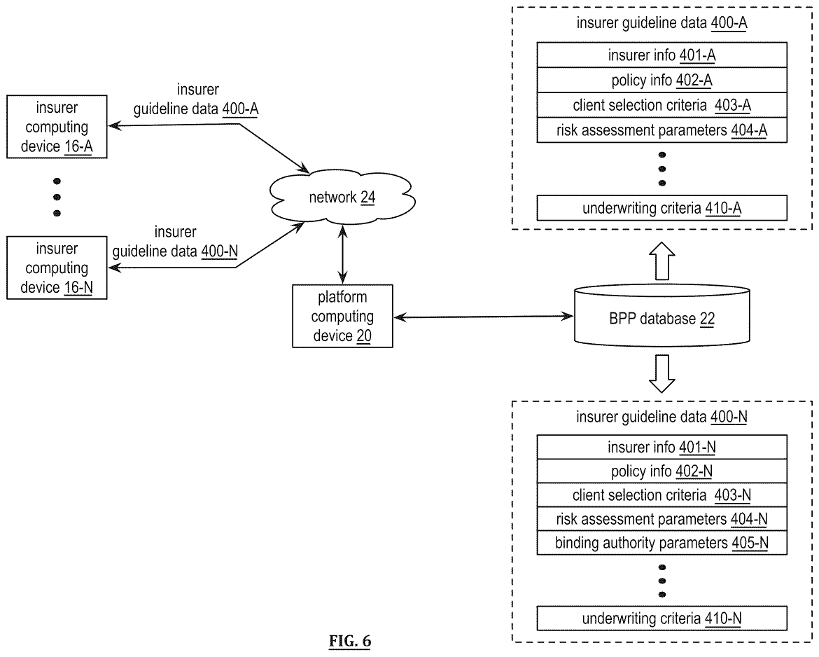

FIG. 6 is a schematic block diagram of an embodiment of ingesting insurer guideline data 400 in a binding policy platform (BPP) network that includes a plurality of insurer devices 16-A through 16-N, a network 24, at least one platform computing device 20 and at least on BPP database 22. The insurer guideline data 400 is utilized to create an account for an insurer, register the insurer with the BPP network, facilitate obtaining insurance quotes, facilitate access to a market access gateway (MAG) module, and optimize interaction of an insurer computing device 16 within the BPP network 10.

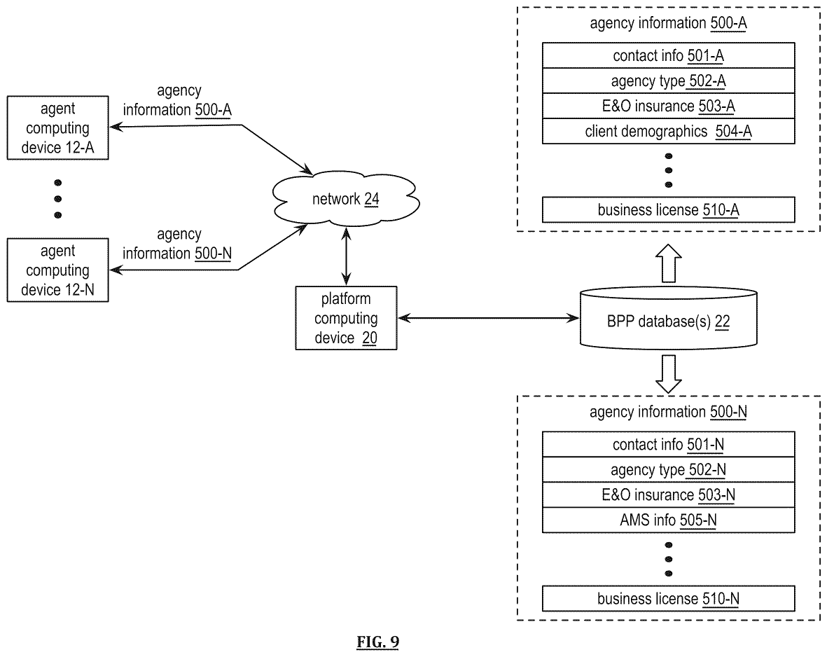

Insurer computing devices 16-A through 16-N provide insurer guideline data 400-A through 400-N to the platform computing device 20. The platform computing device stores at least a portion of the insurer guideline data 400 in the BPP database 22. The platform computing device 20 may organize (e.g., aggregate, sort, and/or otherwise modify) the insurer guideline data 400, which in some examples provides a technological improvement to processing, accessing, utilizing, and/or storing the insurer guideline data 400 or other data (e.g., agency information 500 of FIG. 9). For example, aggregating the insurer guideline data 400 in a first manner may allow the insurer guideline data 400 to be compressed, which saves storage space and improves the memory availability of the BPP database 22. As another example, sorting the insurer guideline data 400 may allow a smaller selection of insurer guideline data 400 to be retrieved to process a query, which decreases the latency and the bandwidth requirements to favorably process the query.

In an example of aggregating, sorting, and/or modifying the insurer guideline data 400, the platform computing device 20 modifies a format of a portion of the insurer guideline data 400 such that the format is consistent with other insurer guideline data 400. As another example of aggregating, sorting or modifying the insurer guideline data 400, the platform computing device 20 combines identical insurer guideline data 400. For example, when both agent type 502-A and 502-N data are the same, the platform device may store a first set of agent type data 502 and add a pointer within other agent information to the first set of agent type data 502. As yet another example of aggregating, sorting, and/or modifying the insurer guideline data 400, the platform computing device 20 receives the insurer guideline data 400 and sorts it into a data table comprised of rows and columns.

The platform computing device 20 can also determine a key column and sort the data table according to the key column. In some examples, the key column is determined based on search data from one or more agent computing devices. For example, when more than a threshold number of searches (e.g., >1000, >50/per hour, etc.) are related to a particular data column of stored information in a data table of database 22, the platform computing device 20 updates the data table such that the particular data column is the key column or an additional key column (e.g., composite key).

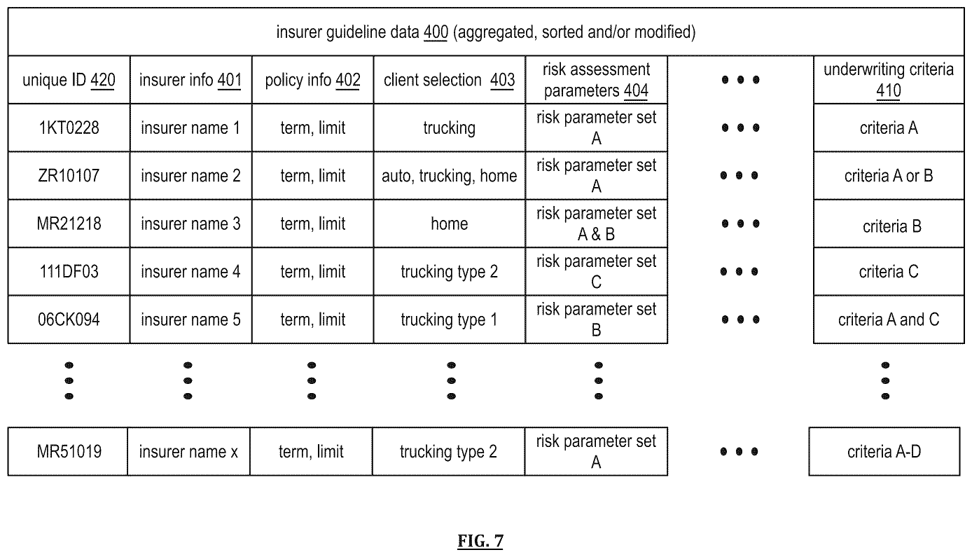

FIG. 7 is a schematic block diagram of an embodiment of insurer guideline data 400 stored in rows and columns of a data table within a BPP database 22. The insurer guideline data 400 can include more or less columns than illustrated, and each column may include multiple data points (e.g., sub-records (nested data), key-value pairs, array, etc.), and/or point to another data field of another data table (e.g., as shown in FIG. 7), and/or point to another data table.

In this specific example, insurer guideline data 400 includes a plurality of fields. The plurality of fields include one or more of a unique ID 420, an insurer info field 401, a policy info field 402, a client selection field 403, a risk assessment parameters filed 404, and so on up to an underwriting criteria field 410. The unique ID 420 may be one or more of a hash (e.g., of a DOT ID #, of a data field of data 400, of a timestamp, etc.), a sequential number, a sequential alphanumerical character, etc. The insurer info 401 may include an insurer name, insurer address, insurer phone number, and other data that identifies a particular insurer.

Policy information 402 includes one or more of a term (e.g., months, years, etc.), a coverage limit (e.g., 500,000 per accident, 3M per year, etc.), a deductible, an additional endorsement (e.g., extra coverage, extra riders, etc.), a policy number, a policy type, an exclusion, a premium amount, etc. The client selection data field 403 includes one or more data points associated with requirements of the client to qualify for a particular policy, which include one or more of a type of policy desired (e.g., auto, trucking, home, etc.), a sub-type of the type (e.g., trucking type 2 (e.g., long haul)), industry of client (e.g., oil, wheat, etc.), etc.

The risk assessment parameters 404 include one or more of location information (e.g., principal place of business of the client, states of operation, etc.), property info, driver information, usage information, cargo details, theft prevention, environmental information (e.g., emission levels), operational practices (e.g., guidance on securing loads), etc. In an example, a risk score can be calculated from one or more data points associated with the client (e.g., info 403 and 404) and pre-determined by the respective insurer. The risk score can be provided to the BPP network which allows for numerous advantages. For example, the risk score can be updated in real time as new data associated with the client is obtained. This allows a prospective client or agency to see how each data point associated with the quote is affecting the policy (e.g., while filling out a unified application, presented as percentages associated with each data point (e.g., 15% of risk score associated with radius of operation value), etc.). The insurer (or another entity with binding authority (e.g., MGA)) can set an acceptable risk score in order to perform one or more of setting a policy premium, accepting or denying coverage, adjusting an underwriting criteria, adjusting a policy coverage limit, etc.

In some examples, the risk score is determined for a client that has a policy near expiration, and a suggested modification to the policy is determined and sent to the insurer for approval. For example, a new risk score for client A is determined one month before the current policy expires. Based on the new risk score increasing 3 points in comparison to a previous risk score, the platform computing device 20 determines a recommended adjustment to the policy is to increase the premium 5% and increase the deductible 10%. The platform computing device 20 sends the recommended adjustment and if accepted by the corresponding insurer, can automatically generate new policy information and send the new policy information to an agent computing device to facilitate binding a new policy according to the new policy information. In some examples, an application operating on a computing device can display information to an entity (e.g., client, agent, etc.) that shows in real time how certain adjustments to the vehicle would affect a policy. For example, the application allows for inputs on vehicle adjustments such as window tint, larger rims, LED lights, etc. and how each vehicle adjustment would affect the policy. As a specific, example, the application receives an input for adjusting the lights on one or more vehicles, to be or that are associated with a policy, to LED lights from halogen lights. The application calculates that a risk score is lowered due to the safety risks associated with LED lights being lower than safety risks associated with halogen lights and shows the effect on the policy would be a reduction of $28.41 per term.

Insurer guideline data 400 (e.g., from a commercial auto/trucking and transportation insurer) may also include underwriting criteria 410. The underwriting criteria 410 includes one or more of vehicle information, driver qualifications, company operations, safety and compliance information, financial health, coverage and policy details, claims management, and insurance history. In an example, the underwriting criteria includes acceptable ranges, and/or values of data points within one or more data fields of other insurer guideline data (e.g., acceptable term=1-3 years, acceptable policy industry type=trucking, acceptable coverage limit <2M, etc.). In some examples, underwriting criteria 410 is utilized to filter prospective quotes in the BPP network. The filtering improves the BPP network and/or the computing devices by reducing unnecessary data transfer, speeding up the quoting process, and decreasing bandwidth requirements. For example, by knowing not to send a particular quote to a 589 out of 655 insurers, a significantly reduced amount of data needs to be transferred and/or stored in a cache memory during a quoting process in the BPP network.

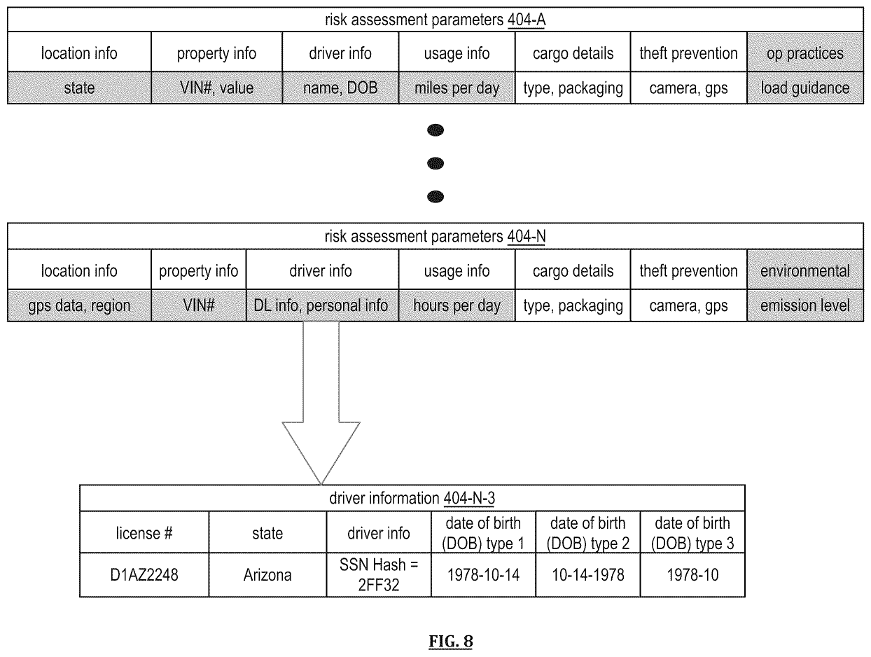

FIG. 8 is a schematic block diagram of an embodiment of risk assessment parameters 404A through 404N stored in rows and columns of a data table within a BPP database 22. As illustrated, the risk assessment parameters 404 may include multiple sub-data fields such as location information, property information, driver information, usage information, cargo details, theft prevention measures, operational practices and environmental data.

The data fields, sub-data fields, and the data type and formats of each field or sub-data field may vary from insurer to insurer. For example, a first insurer associated with risk assessment parameters 404-A may require location information to include a State for one or more of a driver and a vehicle, while a second insurer associated with risk assessment parameters 404-N may require location information to include GPS data and a region (e.g., one or more States, Counties, longitude-latitude coordinates, etc.).

As another example, a first set of risk assessment parameters (e.g., 404-A) includes an operational practices data field requirement and does not include an environmental data field requirement, while a second set of risk assessment parameters (e.g., 404-N) includes an environmental data field requirement and does not include an operational practices data field requirement.

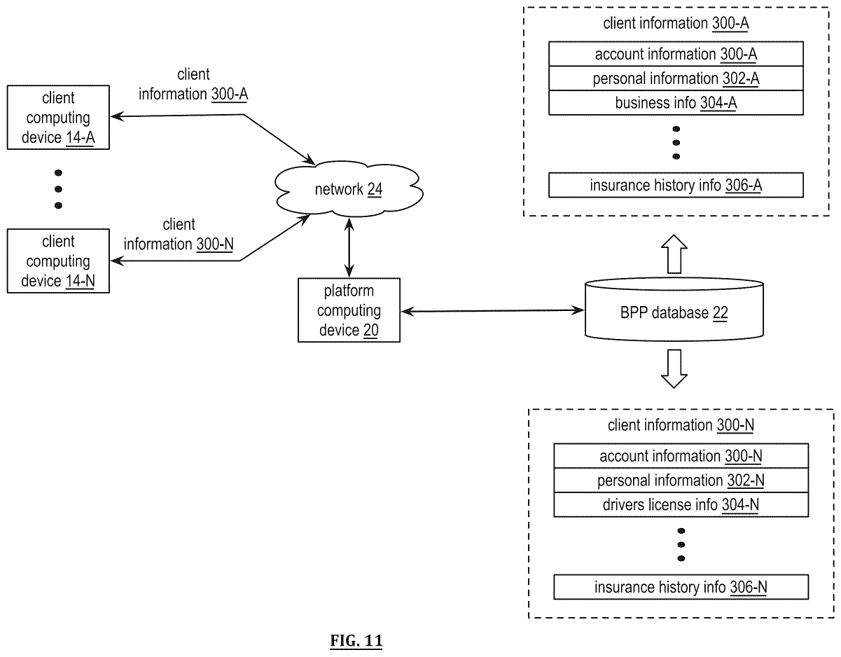

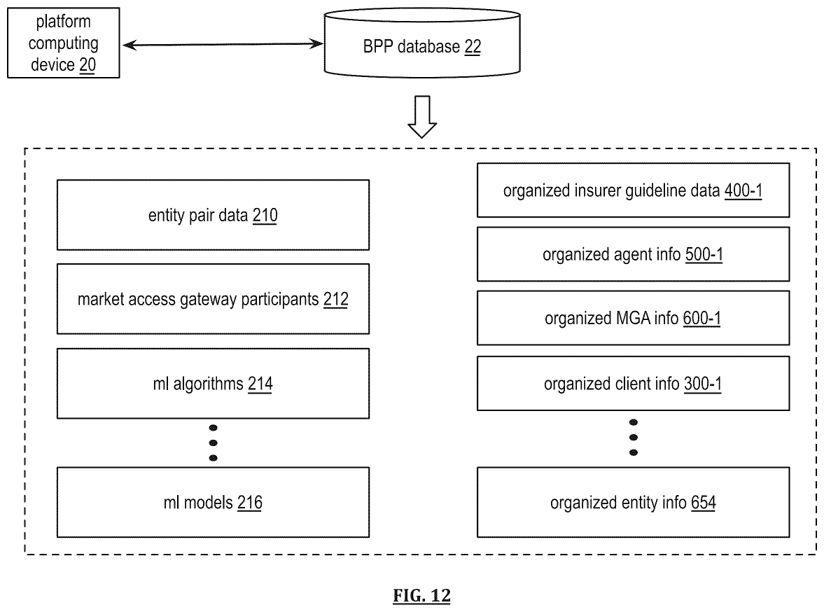

As further illustrated, each data filed may include multiple subfields, as shown by driver information 404-N-3 including as an example a driver's license number field, a state field, a driver information field, and three date of birth (DOB) fields. In an example, this data is extracted from one or more of agency information 500 (e.g., FIG. 9) and client information 300 (e.g., FIG. 11) and is included in organized entity info 654 shown in FIG. 12.

As shown in driver information field 404-N-3, data in the BPP database 22 can be stored in various formats. In some examples, the data is stored in various formats based on different insurer requirements from insurer to insurer. For example, a first insurer requires the DOB format to be YYYY-MM-DD, a second insurer requires the DOB format to be MM-DD-YYYY, and a third requires the DOB format to be YYYY-MM. The BPP database can store this information such that application data associated with a quote request can be submitted to both the first and second insurers in their required formats. In some examples, the required format is saved (e.g., not the formatted data) for at least one of the insurers and the platform computing device 20 modifies the data during a quote request to produce the required formatted data for sending a quote request to the at least one of the insurer computing devices associated with one or more insurers.

FIG. 9 is a schematic block diagram of an embodiment of ingesting agent information 500-A through 500-N in a BPP network 10 that includes a plurality of agent computing devices 12-A through 12-N, a network 24, at least one platform computing device 20 and at least one BPP database 22. The agency information 500 is utilized for one or more of creating an account for an agency, registering the agency with the BPP network, facilitating obtaining insurance quotes, facilitating access to a market access gateway (MAG) module, and optimizing interaction of an agent computing device 12 within the BPP network 10. Note in some examples, an agency or agent may be interchangeable with and referred to herein as a broker.

The platform computing device 20 organizes (e.g., aggregates, sorts, and/or modifies) the agency information 500, which in some examples provides a technological improvement to processing, accessing, utilizing and/or storing the agency information 500 and/or other data (e.g., insurer guideline data 400). For example, aggregating the data (e.g., one or more of data 210-654 stored or to be stored in the BPP database 22) to produce a training set for a machine learning algorithm improves a machine learning model, which may be used to accurately match and/or filter entities of the BPP network, efficiency calculate real time risk scores, etc. As another example, sorting the data may allow a smaller selection of data to be retrieved to process a query, which decreases the latency and the bandwidth requirements to favorably process the query.

At least some of the agency information 500 received by platform computing device 20 is organized and stored in the BPP database 22 in one or more data fields. In some examples, the data fields are stored in a relational database and/or encoded into multiple data chunks. The data fields include one or more of contact information 501, agent type data 502, error and omissions (E&O) insurance info 503, client demographics 504, agency management system (AMS) information 505 and so on up to business license information 510. In an example of organizing the agency information 500, certain information may be included in both a first data field and a second data field. For example, a particular address may be listed in both contact information 501-A and business license 510-A. As another example of organizing and storing the agency information, a data field (e.g., 504-A) generated for first agency information 500-A may be different than a data field (e.g., 505-N) generated for second agency information (e.g., when agency information 500-A includes client demographic data 504-A and agency information 500-N includes ASM information 505-N).

In some specific examples, the agency information 500 includes one or more of a mailing address, a physical address, an email address, a phone number, a number of locations associated with the agency, a company name, an identification of the number of commercial agents within the agency, a tax ID, a primary contact, areas where the agency conducts business, whether the agency has an E&O policy and the E&O's limits, policy number, expiration date etc., identification of a management software the agency is using, etc.

In an example of operation, the platform computing device 20 utilizes first agency information 500-A from agent computing device 12-A to create an account for and/or register a first agency with the BPP network. The platform computing device 20 facilitates the account creation and/or registering by one or more of obtaining the agency information from the agent computing device, obtaining external agency information (e.g., from a trusted resource server), verifying at least some of the agency information and/or the external agency information, setting up security measures (e.g., multi-factor authentication, email verification, biometric authentication, security keys, one-time passcodes, etc.), and providing the agent computing device with login information.

In some examples, the platform computing device 20 obtains market and appointment registration data from the agent computing device 12. The market and appointment registration data includes one or more of an insurance company name, an NAIC (National Association of Insurance Commissioners) number, an API (Application Programming Interface) connection, and a selection of whether the agency wishes to participate in a market access gateway (MAG) program of the BPP network. In a specific example, the platform computing device 20 generates a search dropdown for one or more fields of the market and appointment registration data for quick selection via an interface (e.g., touch screen display) of the agent computing device.

In some examples, a portion of the data can be pre-populated for verification by the agent computing device 12. For example, the platform computing device 20 determines based on insurer guideline data 400 stored in the BPP database 22, that the agency associated with the agent computing device 12 has an appointment with a first insurer. The platform computing device 20 pre-populates the appointment information associated with the first insurer into a data field of a BPP application running on the agent computing device 12. This improves technology by reducing errors from manually typing in the information, and may also reduce the run-time of the application, which saves processing resources, by speeding up the appointment registration process.

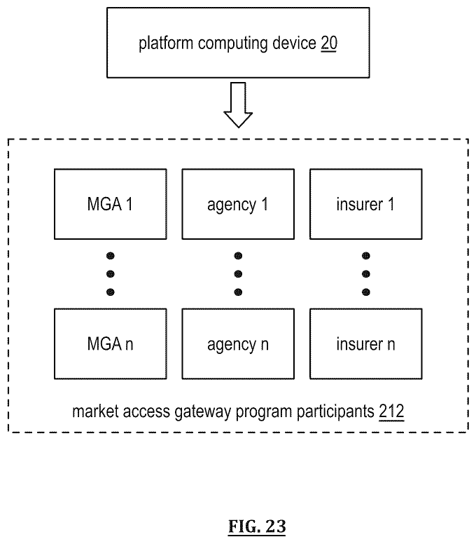

In some examples, the platform computing device 20 requests whether the agency would like to participate in a market access gateway (MAG) program within the BPP network that allows participating entities (e.g., agency, broker, client, insurer, MGA) have access to other entities without a specific contractual or appointment relationship. As example of the MAG program is discussed in greater detail with reference to at least FIGS. 23-26.

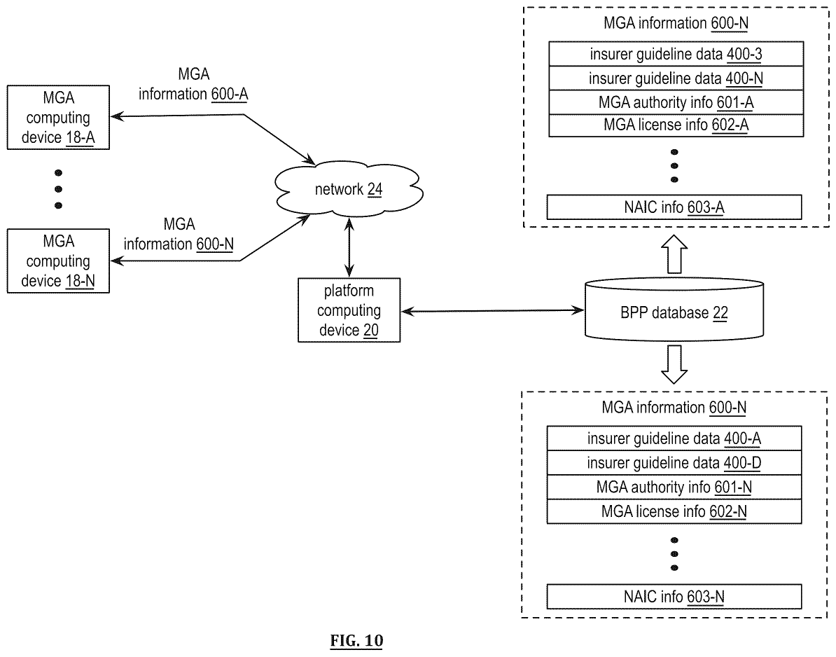

FIG. 10 is a schematic block diagram of an embodiment of ingesting managing general agent (MGA) information 600-A through 600-N in a BPP network 10 that includes a plurality of MGA computing devices 18-A through 18-N, a network 24, at least one platform computing device 20 and at least one BPP database 22. The MGA information 600 is utilized for one or more of creating an account for an MGA, registering the MGA with the BPP network, facilitating obtaining insurance quotes, facilitating access to a market access gateway (MAG) module, and optimizing interaction of an MGA computing device 18 within the BPP network 10.

The platform computing device 20 organizes (e.g., aggregates, sorts, and/or modifies) the MGA information 600, which in some examples provides a technological improvement to processing, accessing, utilizing, and/or storing the MGA information 500 and/or other data (e.g., insurer guideline data 400). For example, aggregating at least some of the MGA information and insurer guideline data to produce a training set for a machine learning algorithm improves a machine learning model, which may be used to accurately match entities (e.g., agencies with an MGA/insurer) of the BPP network, determine fraudulent activity, determine unauthorized access, etc. As another example, sorting the MGA information may allow for a first compression function to be applied to at least a portion of the MGA information 500, which can decrease memory storage requirements of memory of the BPP database 22 for the MGA information.

In an example, the MGA information 500 includes at least a portion of insurer guideline data 400 (e.g., for insurance companies the MGA has an appointment with), MGA authority info (e.g., proof of appointment, claims handling information, underwriting guidelines, policy administration, etc.), MGA licensing information 602, and so on (e.g., operational capabilities, risk appetite, etc.) up to NAIC information 603.

FIG. 11 is a schematic block diagram of an embodiment of ingesting client information 300-A through 300-N in a BPP network 10 that includes a plurality of client computing devices 14-A through 14-N, a network 24, at least one platform computing device 20 and at least one BPP database 22. The client information 300 is utilized for one or more of creating an account for a client and/or in conjunction with creating an account for an agent, registering the client with the BPP network, facilitating obtaining insurance quotes, facilitating access to a market access gateway (MAG) module, and optimizing interaction of a client computing device 18, agent computing device, or other entity within the BPP network 10.

The platform computing device 20 may organize (e.g., aggregate, sort, and/or modify) the client information 300, which in some examples provides a technological improvement to processing, accessing, and/or storing the client information 300 and/or other data (e.g., insurer guideline data 400). For example, aggregating the client information 300 to produce a training set for a machine learning algorithm improves a machine learning model, which may be used to accurately match entities of the BPP network, determine fraudulent activity, determine an abnormality, determine unauthorized access, etc. As another example, sorting the client information 300 may allow a smaller selection of data to be retrieved to process a query, which decreases the latency and the bandwidth requirements to favorably process the query.

The client information includes one or more of account information 300 (e.g., username, email, password, etc.), personal information 302 (e.g., name, age, driver's license, etc.), business information 304 (e.g., name of LLC, number of employees, physical address, etc.), insurance history information 306 (e.g., driving history, claims history, policy info, etc.), etc.

FIG. 12 is a schematic block diagram of an embodiment of a BPP database 22 of a BPP network 10 that includes a platform computing device 20. As illustrated, the BPP database 22 stores one or more of entity pair data 210, market access gateway participants 212, machine learning algorithms 214, machine learning models 216, organized client information 300-1, organized insurer guideline data 400-1, organized agent information 500-1, organized MGA information 600-1, and organized entity information 654.

Organized entity information 654 includes one or more data points of any two or more of the entity pair data 210, market access gateway participants 212, machine learning algorithms 214, machine learning modules 216, organized client information 300-1, organized insurer guideline data 400-1, organized agent information 500-1, and organized MGA information 600-1. For example, organized entity information 654 includes an entity pair identification and the machine learning module used in forming the entity pair. As another example, organized entity information 654 includes a subset of 10 data rows of MGA information 600-1 and a subset of 55 data rows of organized insured guideline data 400-1.

As yet another example, organized entity information 654 includes a data field from organized client info 300-1 and a plurality of data fields from agent info 500-1, where the data field and the plurality of data fields form a row that corresponds to a data record within organized entity info 654. In some examples, certain data in the database 22 is stored in accordance with a flat file, XML (extensible markup language), key-value stores, object storage, time-series databases, block storage, blockchain, etc.

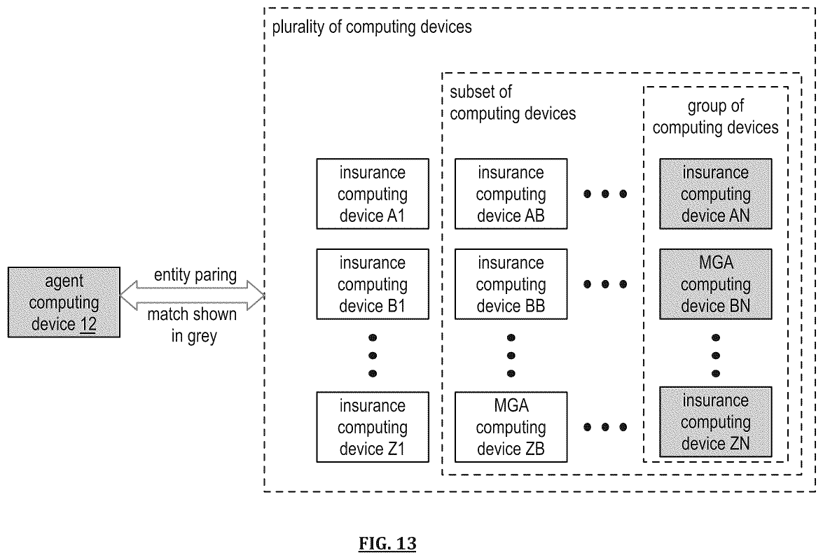

FIG. 13 is a schematic block diagram of an embodiment of determining entity pairs in a binding policy platform (BPP) network. An entity pair is one or more of two entities that have an appointment relationship, and two entities that have a plurality of data points in common such that a pairing function determines a likelihood of establishing an appointment exceeds a threshold. In an example, the entity pairs determine which computing devices receive a quote request for a one-click submission. An entity of the entity pairs is one or more of a client (as associated with one or more client computing devices 14), an agency (as associated with one or more client agent computing devices 12), an insurer (as associated with one or more insurer computing devices 16), and a managing general agent (MGA) (as associated with one or more managing general agent computing devices 18).

As illustrated, an agent computing device 12 is paired with a group of computing devices that includes one or more insurance computing devices and/or one or more MGA computing devices. Note that the pairing (and also an unpairing process) may be done based on one or more of client information 300, insurer guideline data 400, agency information 500, MGA information 600, organized entity info 654, output of a machine learning (ML) model (e.g., based on an ML algorithm trained on BPP data 300-654), output of a neural network (e.g., weights based on BPP data 300-654), executing a function, a command, detecting a change, and a pre-determination.

As an example, the platform computing device 20 executes a machine learning model on one or more of the agency information 500, the insurer guideline data 400, and the MGA information 600 to produce one or more matches between the agent computing device 12 and a plurality of computing devices, which produces a group of computing devices. As another example, the platform computing device 20 determines to unpair an entity pair based on a device associated with the entity pair being removed from the BPP network. As yet another example, the platform computing device 20 determines a pair between agent computing device and insurance computing device ZN based on appointment information from agent information 500.

In some examples of matching entities of the BPP network 10 to produce an entity pair, a first subset of the plurality of computing devices are selected (e.g., filtered from the plurality of computing devices) based on agency information 500 associated with an agent computing device 12 and a plurality of insurer guideline data for each insurer associated with the plurality of computing devices. For example, the platform computing device 20 determines which insurers would accept the agency associated with agent computing device 12 associated with an agency based on a type of clients (e.g., long haul trucking) the agency services. As another example, platform computing device 20 determines which MGAs would accept the agency associated with agent computing device 12 based on a location the agency serves. From the subset of computing devices, the platform computing device 20 executes a machine learning algorithm on client data associated with a quote request from the agent computing device 12 to determine entity pairs.

As a specific example, the subset of computing devices are determined by based on an acceptable risk score range for insurers that the agent computing device 12 (e.g., agency 1) has determined based on its risk appetite. For example, the agent computing device 12 wishes to work with insurers/MGAs that have an accepted risk score range of 0-25 on a 0-100 scale. A selected deterministic function is executed on insurer guideline data and/or MGA information associated with the plurality of computing devices to produce a plurality of risk scores. The computing devices that are associated with an insurer/MGA that have a risk score between 0-25 (e.g., 3, 22, 17, etc.) are added to the subset of computing devices.

The platform computing device 20 determines out of the subset of computing devices, which computing devices are associated with insurer guideline data that matches a data point of a quote request to produce the group of computing devices. For example, the platform computing device 20 determines to add insurance computing device AN to an entity pair for the agent computing device 12 based on a policy limit for insurance company AN of 2 million, and a requested policy amount for the quote request of 1.5 million (e.g., compares favorably).

Note the matching to produce entity pairs may be determined for a particular transaction, for all transactions, for a subset of transactions, for a particular time period, for a particular entity, etc. For example, the platform computing device 20 may determine to update entity pairs for an agent computing device every 5 minutes and to update entity pairs for an insurer computing device every 30 days. As another example, the platform computing device 20 may determine to update entity pairs every time a new device is added to the BPP network. As yet another example, the platform computing device 20 may determine to update the entity pairs every 200 transactions within the BPP network. As still yet another example, the platform computing device 20 may determine to update entity pairs pseudo randomly for a particular entity every 50, 200, 50, 100, 50, 200, 50, 100, etc. transactions associated with the particular entity.

In some examples, entity pairs include various entity pairing levels. For example, a first entity pairing level is in accordance with appointment information, a second entity pairing level is in accordance with commonality between data points associated with an agency and corresponding insurance entities (e.g., insurers, MGAs) that can be paired, and a third entity pairing level is in accordance with quote data regarding a client and policy options available from the insurers in the second entity pairing level. The levels can be used to determine one or more of timing of quote requests (e.g., send quote request to first entity pairing level, after 5 minutes send quote request to computing devices associated with second entity pairing level, etc.), selection of computing devices to send quote requests (e.g., only first entity pairing level), and quote recommendations (e.g., only recommend quote from first entity pairing level, list recommend quotes in order of their pairing level, etc.).

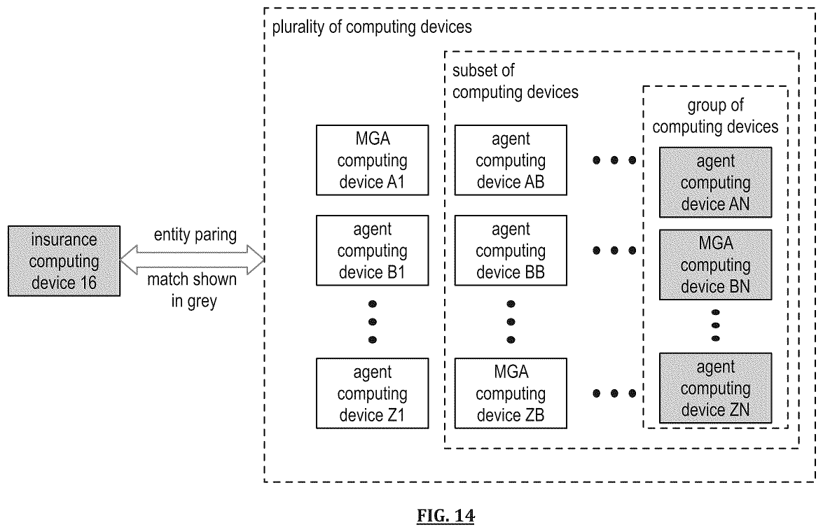

FIG. 14 is a schematic block diagram of an embodiment of entity pairs between an insurer computing device 16 and a group of computing devices of a subset of computing devices of a plurality of computing devices. In this example, the insurance computing device is paired with one or more agent computing devices and one or more managing general agent computing devices. Note in some examples, the group of computing devices is determined from the plurality of computing devices (e.g., no filtering the plurality of computing devices into the subset of computing devices), and/or only from appointment data.

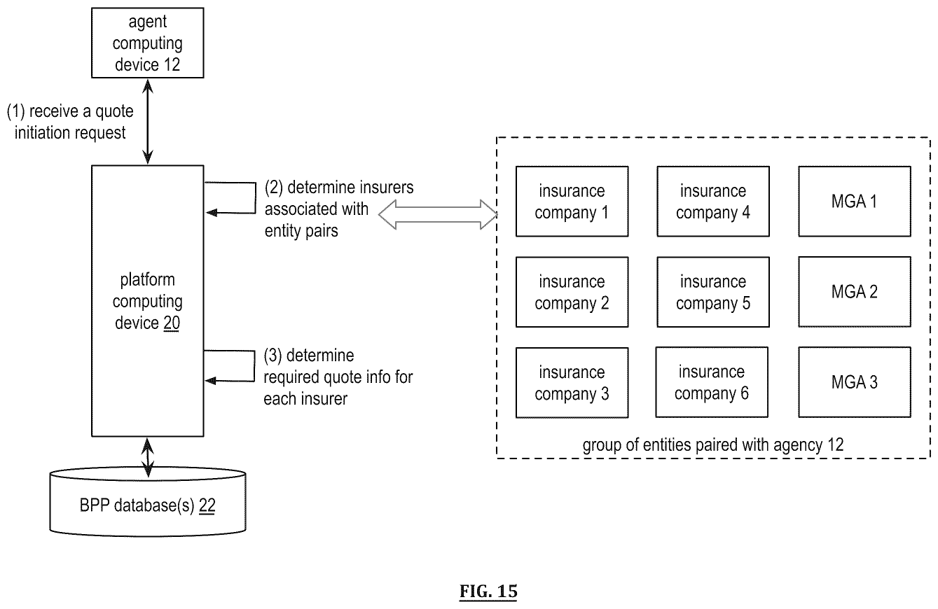

FIGS. 15-17 are schematic blocks diagrams illustration an embodiment of generating unified application information in a binding policy platform (BPP) network that includes at least an agent computing device 12, a platform computing device 20, a group of entities paired with the agency associated with the agent computing device 12, and a BPP database 22.

In an example of operation, FIG. 15 illustrates the platform computing device 20 receiving a quote initiation request from an agent computing device. In an example, the quote initiation request is logging into an application associated with the BPP network by the agent computing device utilizing BPP account credentials. In another example, the quote initiation request is receiving a message from the agent computing device. In yet another example, the quote initiation request is receiving an indication that a user of agent computing device 12 selected a start quote button displayed via an application of the BPP network on a display of the agent computing device 12.

The example optionally includes the platform computing device 20 determining insurers/MGAs associated with entity pairs of the agent computing device 12. For example, the platform computing device 20 determines insurance company 1, insurance company 2, and insurance company 3 are paired (e.g., as entity pairs based on appointment data) with an agency associated with the agent computing device 12.

Note in some examples, the insurance companies are determined based on one or more of projected insurer application requirements and an estimated entity pair match. For example, for a quote request where the agent computing device 12 is not currently paired with any managing general agent computing device or insurer computing device, and/or when the agent computing device 12 indicates in the quote imitation request that the quote is only for submission via a market access gateway module, the platform computing device 20 may determine the group of insurance companies based on one or more of agent information associated with the agent computing device 12, insurer requirements for a number (e.g., all, a top rated 100, a subset, etc.) of insurance companies registered to receive quote requests via the market access gateway module, and receiving a command.

The platform computing device 20 determines required quote information for each insurer determined in the group of insurance companies. Note in some example, the required quote information is determined for a plurality of insurers that are not currently included in the group of computing devices. Further note that at least one data point from a first insurer is different than a similar data point from a second insurer. For example, a first insurer requires a date of birth field (e.g., data point) in a YYYY-MM-DD formant and a second insurer requires a date of birth field in a MM-DD-YY format. As another example, a first insurer requires a data field regarding electronic logging devices in a safety device column, while a second insurer does not have a data field titled “electronic logging devices” in its safety device column, and a third insurer uses a data file title of “a tracking device” regarding a similar data field of its safety device column, where an agent would input data regarding electronic logging devices.

Note in some examples, the method to determine required quote information for each insurer is performed before receiving a quote initiation request. For example, the determining required quote information may be performed on a periodic basis, on determining a change (e.g., addition or removal of an entity within the BPP network), receiving a command, determining common insurer requirements for over a threshold number of active insurers (e.g., 90%) in the BPP network, etc.

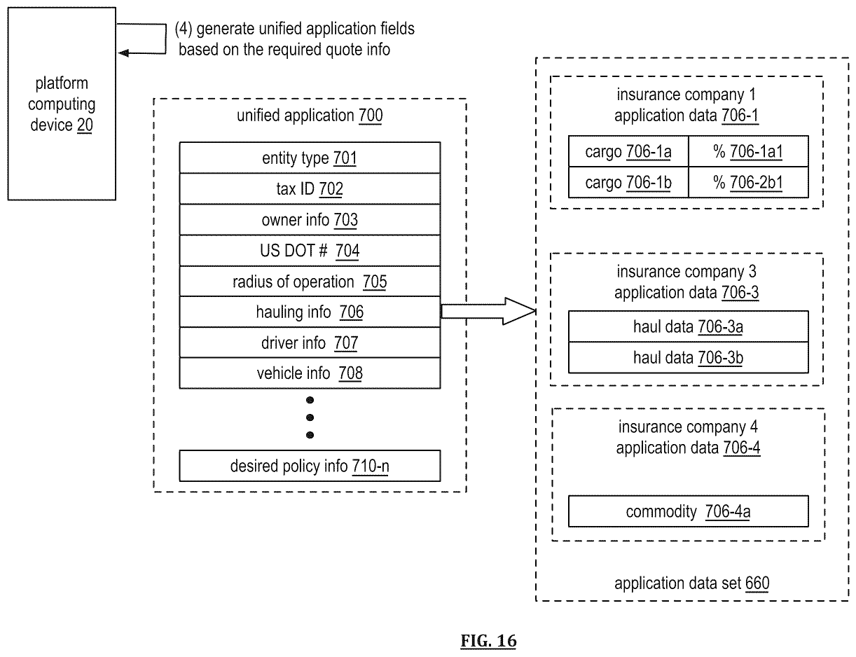

This specific example continues with FIG. 16, where the platform computing device 20 generates unified application information 700 based on the required quote information. In general, an application data set for each computing device of a group of insurance companies that include at least one differing application data requirement can be accurately generated based on data in the unified application information fields 701-710-n. In an example, when two insurance companies have the same application data requirements, the application data sets for the two insurance companies can be the same application data set (e.g., unmodified unified application information 700). The unified application information includes a majority, up to all the information needed to bind a policy within the BPP network. For example, the unified application information includes 90% of the required information to bind, where the 90% is enough information (e.g., pre-binding requirements) to solicit a quote from an insurer/MGA for an application for a policy, and the remaining 10% is additional information (e.g., signatures, certain financial disclosures, etc.) needed to finalize the policy after the quote is accepted.

In some examples, the unified application information data fields includes an entity type field 701, a tax identifier field 702, an owner information field 703, a United States Department of Transportation number field 704, a radius of operation field 705, a hauling information field 706, a driver information field 707, a vehicle information field 708, and so on up to a desired policy information field 710-n. In some examples, the unified application information data fields include one or more different data fields depending on application requirements associated with the group of insurance companies.

In some examples, the data fields are generated as one or more of a text input (e.g., single line text field, multi-line text field), a selection (e.g., dropdown list, multiple select, radio buttons, checkboxes, etc.), a numerical input (e.g., number, date (e.g., via a date picker) time, etc.), a specialized input (e.g., file upload, range slider, etc.), an autocomplete input (e.g., predictive text as user types), a toggle switch button, etc. In some examples, a data field is limited (e.g., won't accept, will not allow user to move to a next screen or submit, etc.) to a number of alphanumerical characters, limited to a range of acceptable values, and limited to subset of options based on another field selection, value, etc.

For example, a first data field only allows numerical values from 500,000 to 2,000,000. As another example, a second data field only accepts an alphabetic text input of 8 characters. As another example, a third data field changes its dropdown options based on the input and/or selection of the first data field. For example, when 500,000 is the input, a first subset of options are shown and/or selectable a dropdown, and when 2,000,000 is the input, a second subset of options are shown and/or selectable in the dropdown.

Thus, the unified application information data fields provide a technological improvement as shown in some of the examples described herein to increase accuracy, reduce errors, reduce rejected applications, allow for one-click submissions in a BPP network, etc., which can improve one or more of a latency in processing a request (e.g., quote, update policy, etc.), memory capacity requirements (e.g., maintaining certain application information in a cache while re-obtaining correct data to resubmit application based on a rejection, etc.), decreasing bandwidth, more intuitive interface, etc.

In some examples, the data fields may be pre-populated or omitted as displayed in a centralized application interface of the BPP network. For example, a tax ID is associated with a US DOT # in a trusted resource database. When the tax ID is entered into the unified application, the US DOT # can be retrieved and automatically populated in the field 704 for review by the agent computing device. As another example, a US DOT #is associated with owner information 703 is stored in BPP database 22 (e.g., as business information 304).

In an example, the data fields may include multiple application data points for each data field of unified application 700. For example, a first insurance company requires haul information 706 to be listed as types of cargo 706-1a and 706-1b and a percentage of each cargo type 706-1al and 706-2b1, while a third insurance company requires a “haul data” fields 706-3a and 706-3b to include an identification of what the client is hauling, while a fourth insurance company requires a “commodity” field 706-4a to include an identification of a particular commodity the client is hauling.

The platform computing device 20 generates unified application questions and/or fields to reduce (e.g., minimize, decrease by 20%, eliminate a data field, etc.) the necessary information required from the agent computing device in order to submit a quote to the BPP network. As a specific example, the platform computing device 20 generates an application question for the input of the hauling info data field 706 to be “What commodities (including percentages of) does your client transport?”.

In this specific example, the agent computing devices enters corn at 40% and wheat at 60%. The platform computing device 20 determines from this input to generate the following application data points for inclusion in an application data set 660:706-1a=wheat, 706-1b=corn, 706-1a1=60%, 706-2b1=40%, 706-3a=wheat, 706-3b=corn, 706-4a=grain (e.g., when wheat and corn can both be classified as a grain). As such, when sending out quotes, each quote request is able to conform to the requirements of each of the insurers such that each insurer is able to determine whether and how they would like to generate a quote reply without needed additional information.

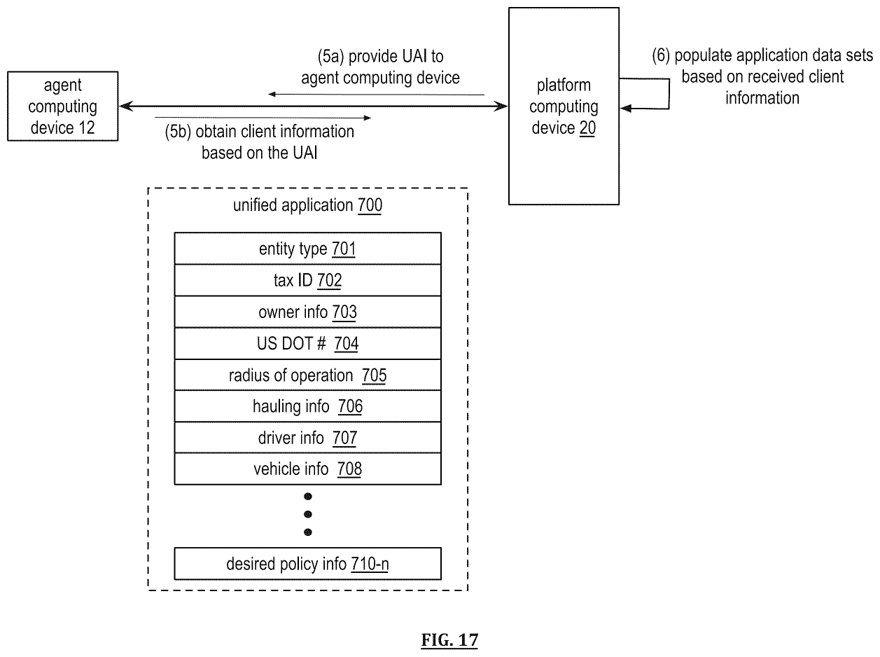

The example continues with FIG. 17, where the platform computing device 20 provides the unified application information to the agent computing device 12. In an example, the unified application information is provided by an application running on the agent computing device. In another example, the unified application information is provided via a website application associated with the BPP network. The example continues with obtaining the unified application information from the agent computing device 12. Note in some examples, a portion of the unified application information is obtained from the agent computing device and another portion of the unified application information is obtained from a third party (e.g., a trusted resource server 30, a verification server 32, a rule server 34, a blockchain, etc.) and/or the BPP database (e.g., based on a previous application for the entity pair, etc.).

In this example, once the information in the unified application information data fields is obtained, the platform computing device 20 has enough information to ensure different applications associated with insurers to be sent a quote request can be automatically created and/or filled out (e.g., as shown with reference to FIG. 16). The platform computing device 20 generates a plurality of application data sets and sends the plurality of application data sets to a plurality of entity pairs of the BPP network to solicit a quote response.

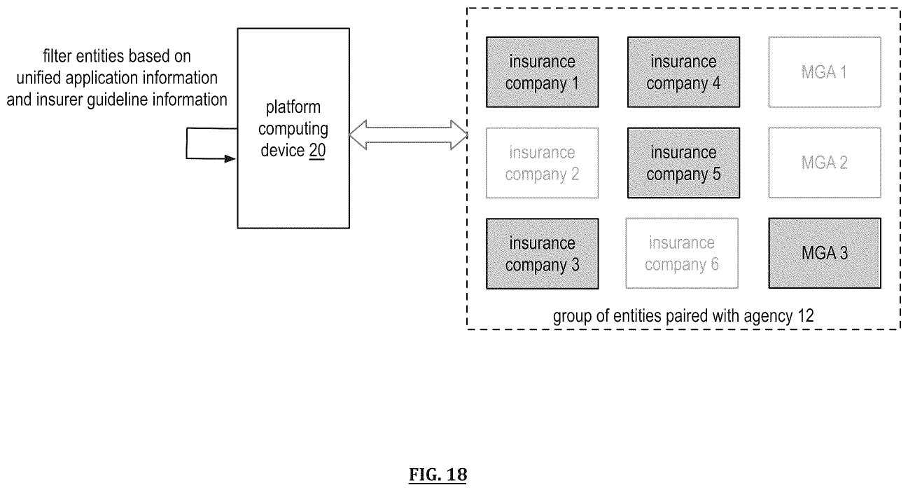

FIG. 18 is a schematic block diagram of an embodiment of filtering entities in a BPP network. In some examples, the platform computing device 20 filters entities based on the unified application information and insurer guideline information associated with the group of entities. For example, when one or more data points (e.g., a threshold, specific number, etc.) of the unified application information does not compare favorably (e.g., not within a range of values, not a particular value, etc.) with insurer guidelines associated with an insurance company, the platform computing device 20 determines to filter out computing devices associated with the insurance company such that a subsequent submission for a quote will not be sent to an insurer computing device associated with insurance company.

In this specific example, the platform computing device 20 determines that insurer guideline data associated with insurance company 2, insurance company 6, managing general agent 1, and managing general agent 2 compares unfavorably to the unified application information (e.g., obtaining in the example of FIGS. 15-17. Thus, platform computing device 20 determines to send a quote request regarding the unified application information to computing devices associated with insurance companies 1, 3, 4, and 5, and to managing general agent 3.

In some examples, the filtering is performed on a plurality of computing devices, where at least some of the insurer computing devices or managing general agent computing devices do not have an appointment with an agency. Note the filtering may include multiple filters. For example, a first filter removes insurance companies that do not offer policies in a particular region to produce a subset of insurance companies, and a second filter then removes insurance companies that do not offer policies over 2,000,000 in coverage to produce a second subset of insurance companies.

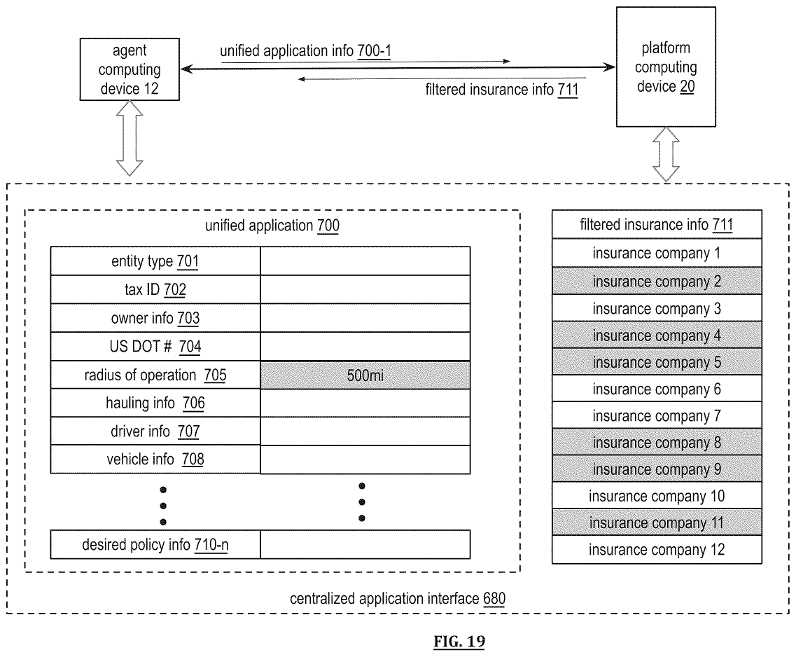

FIG. 19 is a schematic block diagram of an embodiment of filtering entities (e.g., insurance companies) in a BPP network. In this example, a centralized application interface 680 of a BPP application is shown that is displayed on a display of one or more computing devices of the BPP network. The agent computing device enters unified application info 700-1 into a window of an application displayed on the agent computing device. The platform computing device 20 operates to produce filtered insurance info 711. In some examples, the platform computing device 20 is implemented by a BPP application running on or accessible to the agent computing device 12.

In this specific example, a value of 500 miles is entered into the radius of operation field 705. In some examples, the insurance companies that are matches based on the entered radius are highlighted (e.g., in real-time, after field is unselected, etc.) in a filtered insurance companies visual list within the centralized application interface 680. For example, insurance companies 2, 4, 5, 8, 9 and 11 all include policies that have allowable ranges of 500 miles or greater.

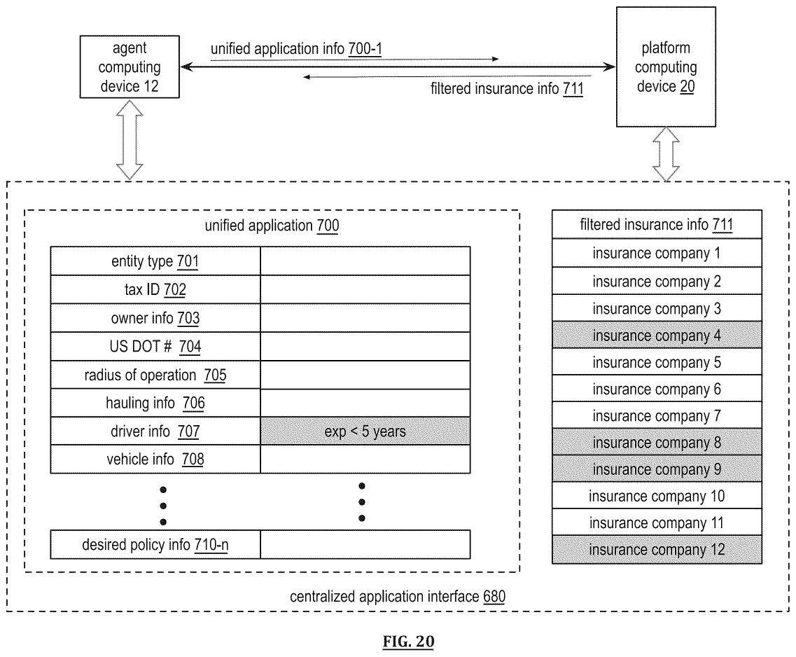

FIG. 20 is a schematic block diagram of an embodiment of another example of filtering entities in a BPP network. In this example, a value of less than 5 years is entered by an agent computing device 12 into a driver information filed 707 of unified application 700. The platform computing device 20 determines based on the entered value that insurance companies 4, 8, 9, and 12 would accept this based on corresponding insurer guideline data. The list of insurers that are still valid are shown on the centralized application interface for displaying on a display of the agent computing device. In some examples, only the insurance companies that are associated with insurer guideline data that compares favorably to the inputted data into the unified application 700 are shown on the centralized application interface. For example, once the value of the driver info 707 field is input as less than 5 years, insurance companies 1, 2, 3, 5, 6, 7, 10, and 11 are removed from the list.

In some examples, the filtered insurance companies are not shown until after one or more fields are inputted with a value. For example, a user of the agent computing device enters a value of experience less than 5 years in the driver info field 707 and hits enter, and then the filtered list is displayed.

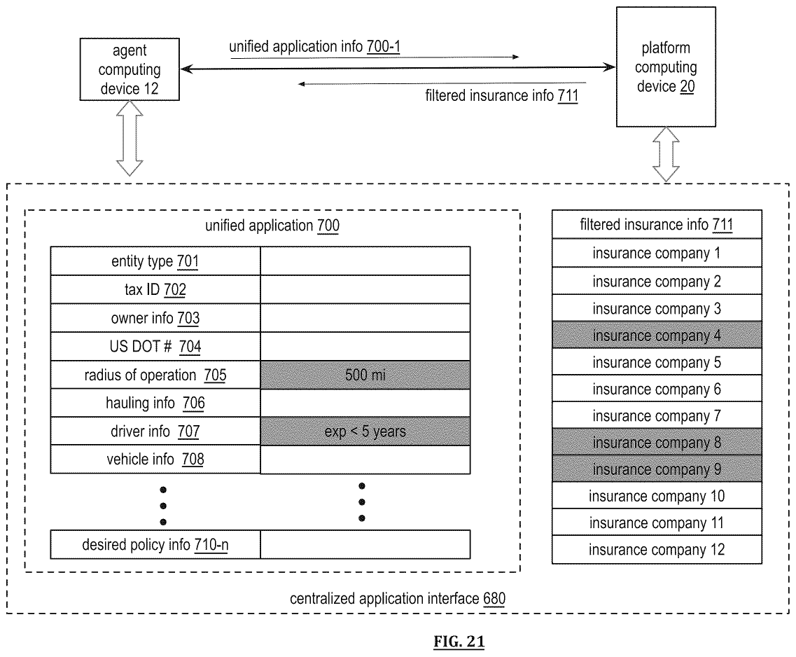

FIG. 21 is a schematic block diagram of an embodiment of another example of filtering entities in a BPP network. In this example, both the inputs of FIGS. 19 and 20 are shown in the radius of operation field 705 and the driver information field 707. When combined, the platform computing device 20 determines that insurance companies 4, 8, and 9 have associated insurer guideline data that compares favorably (e.g., allowable radius is >=50 miles, allowable driver experience <5 years) to the inputted client data by agent computing device 12 and shows an indication of the favorable comparison in the application window displayed by the centralized application interface 680.

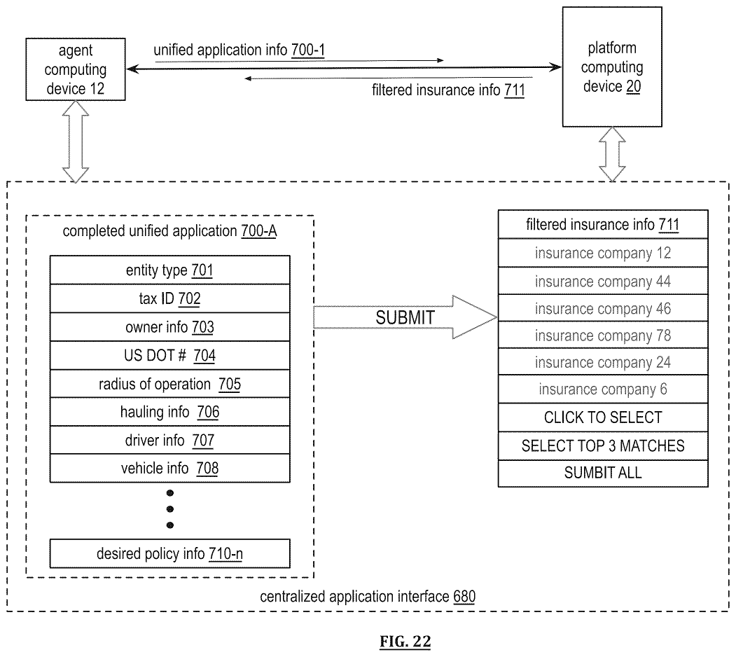

FIG. 22 is a schematic block diagram of an embodiment of another example of filtering entities in a BPP network. In this example, the inputted data of completed unified application 700-A is compared with insurance guideline data associated with a plurality of insurance companies registered with the BPP network. Once a submit option is selected in the centralized application interface 680, the platform computing device 20 determines insurer guideline data for insurance companies 12, 44, 46, 78, 24, and 6 compares favorably with information (e.g., one or more data points) in the completed unification application 700-A and causes an identification of the insurance companies to be displayed within the centralized application interface 680.

In an example, from the displayed list of insurance companies, the agent computing device can click to select one or more of the insurance companies, automatically select the top 3 (e.g., or another number) matches, or submit to all insurance companies listed. The platform computing device 20 receives the selection from the agent computing device and sends a quote request regarding the completed unified application 700-A to computing devices associated with the selected insurance companies to solicit a quote reply.

FIG. 23 is a schematic block diagram of an embodiment of a market access gateway participants 212 of a BPP network 10. In this example, the platform computing device 20 determines a plurality of entities to add as market access gateway participants 212 to a market access gateway (MAG) program, which is accessible by a plurality of entities of the BPP network via a market access gateway module 44. As an example, when an entity (e.g., agency, insurance company, managing general agent computing device, etc.) registers with the BPP network, the entity can be added to the market access gateway program. In some examples, the platform computing device 20 sends a message to the entity soliciting participation in the MAG program.

The market access gateway program functions to allow entities within the BPP network to discover insurers, agents, MGAs, and clients the entities would otherwise not have access to each other, and also functions to streamline appointment and/or contracting between agents and MGAs/insurers. In some examples, an agent computing device 12 submits a quote request to the market access gateway participants via the MAG module 44, and without the agent computing device knowing which participants have reviewed the application associated with the quote request, the MGA module allows an insurer computing device or managing general agent computing device to review the application to determine whether the insurer/MGA wants to provide a quote reply to bid for binding a policy associated with the quote request. For example, for a submitted quote request to the market access gateway module, a first insurer computing device is shown a risk score associated with the quote request.

As another example, for a submitted quote request, a second insurer computing device is shown a subset of data fields, and the second insurer computing device can determine whether or not to submit a quote reply in order to bid for business (e.g., binding an insurance policy) associated with the submitted quote request. As yet another example, a managing general agent computing device is shown an industry type and coverage amount associated with the quote request, and the managing general agent computing device can determine based on the industry type and coverage amount whether to submit a quote reply or receive additional information needed in order to bid for business associated with the submitted quote request.

In some examples, once an insurer or MGA has accepted a quote request by providing a quote reply, the platform computing device 20 can provide the following one or more options for an agent computing device: (a) alert that an appointment with the agent computing device is desired; (b) alert that only the quote is approved (e.g., no appointment offered); (c) alert that appointment is under review (e.g., insurer would like to complete 10 policy binds with the agent computing device before offering an appointment); and (d) alert that agent computing device can begin the binding process for the requested policy.

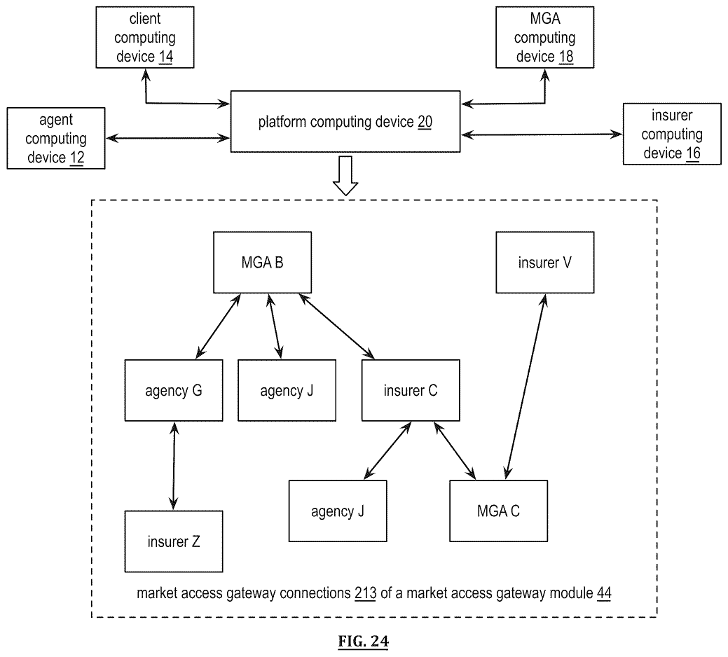

FIG. 24 is a schematic block diagram of an example of market access gateway connections 213 of a market access gateway module 44 in a BPP network 10. The market access gateway module 44 determine connections between managing general agents (MGAs), insurers, and agencies of the BPP network. In some examples, the connections are stored in a hierarchical structure as root nodes, internal nodes, and leaf nodes. The structure can determine which participants of the MAG a quote request is sent to in order to solicit a quote reply. A connection indicates one or more of an appointment relationship, an entity pair of the BPP network, and at least a threshold number of one or more of quote requests sent, quote replies sent, and policy binds completed.

As an example, a platform computing device 20 determines that insurer C has appointments with MGA B, MGA C and agency J. As such, the platform computing device 20 can determine whether to send a quote request to each participant (e.g., MGA B, MGA C, agency J, & insurer C), to a subset of participants (e.g., MGA C and agency J), or one participant (e.g., insurer C). In some examples, the platform computing device 20 determines the participants based on a tree traversal algorithm.

In some examples, this structure provides a technological benefit as it may reduce redundant quote requests (e.g., sending the quote request to the same insurer/MGA twice), reduce redundant quote replies (e.g., multiple approvals by same insurance company for same quote) among other advantages. For example, based on how the entities are connected (common threshold number of like connections), the MAG module 44 determines a high likelihood that an insurer and MGA that currently are not connected would engage in business with one another if presented the opportunity. Thus, the platform computing device 20 can execute a deterministic function on the MAG connections 213 structure to determine a list of entities to send a pair message to determine whether or not those entities could be added to an entity pair within the BPP network.

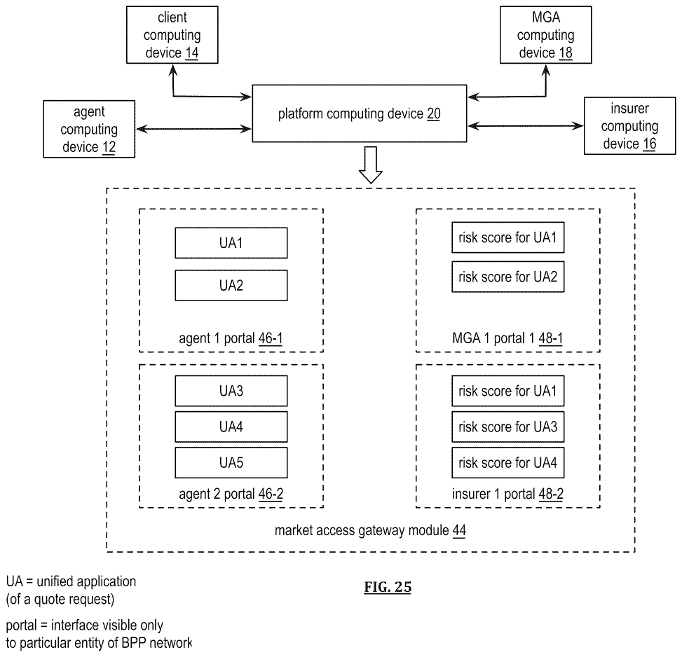

FIG. 25 is a schematic block diagram of an embodiment of a market access gateway (MAG) module 44 of a binding policy platform (BPP) network, that includes an agent computing device 12, a client computing device 14, a managing general agent computing device 18, a platform computing device 20, and an insurer computing device 16. Each entity has a portal in the market access gateway module, where the entity can interface with an application of the BPP network to bind policies with other entities. For example, agent 1 has a portal 46-1, agent 2 has portal 46-2, MGA 1 has a portal 48-1, and insurer 1 has a portal 48-2. A portal is an interface that is only available to and/or visible on a particular computing device (e.g., agent computing device). In some examples, the portal is accessible in a centralized application interface of the BPP network 10.

As illustrated, the MAG module 44 facilitates quote request submissions for unified applications (UAs) 1-2 from agent 1 and UAs 3-5 from agent 2. In this example, the MGA 1 is shown a risk score for UAs 1-2 and not any information for quotes UAs 3-5 submitted by agent 2. In an example, the lack of information for UAs 3-5 is based on MGA information requiring a particular type of trucking (e.g., short haul) and agent 2 is not associated with any agent information that indicates short haul trucking. Insurer 1 portal 48-2 shows risk scores for UAs 1, 3 and 4 based client information comparing favorably to insurer 1's insurer guideline data.

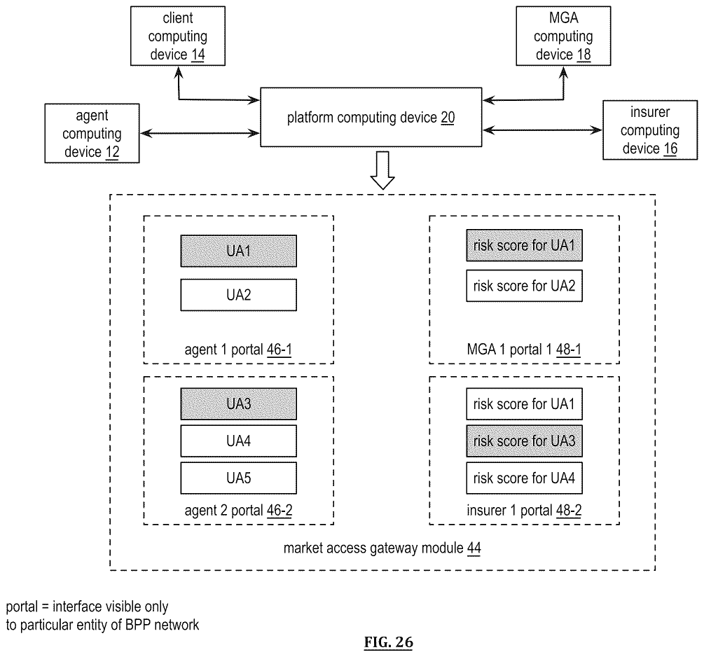

FIG. 26 is a schematic block diagram of an embodiment of a market access gateway module as shown in FIG. 25, with an agent 1 portal 46-1 showing an indication that a quote request associated with unified application (UA) 1 submitted to the market access gateway module has received a quote reply (e.g., from MGA1), agent 2 portal 46-2 showing an indication that a second quote request associated with unified application (UA) 3 submitted to the market access gateway module has received a second quote reply (e.g., from insurer 1). MGA 1 portal 1 48-1 shows that the MGA 1 selected UA1 to provide a quote reply, and insurer 1 portal 48-2 shows insurer 1 selected UA3 to provide a quote reply.

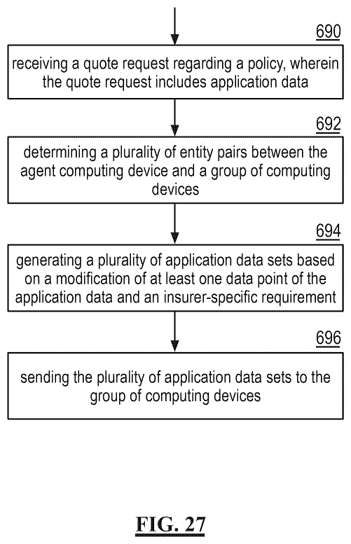

FIG. 27 is an example of a method of execution by one or more platform computing device(s) within a binding policy platform (BPP) network to facilitate novel data transfer within an insurance quote process. The method includes step 690, where the platform computing device receives a quote request from an agent computing device, where the quote request includes application data (e.g., in one or more data fields) related to a policy and a client.

The method further includes step 692, with the platform computing device determining entity pairs within the BPP network, where each entity pair includes the agent computing device and a corresponding computing device from a group of computing devices that includes one or more insurer computing devices and one or more managing general agent computing devices. In some examples, the method includes selecting the group of computing devices from a plurality of computing devices, where the plurality of computing devices includes a plurality of managing general agent computing devices and a plurality of insurer computing devices. In some examples, the determining the plurality of entity pairs includes determining a plurality of insurer computing devices and a plurality of managing general agent computing devices that are identified as having an appointment relationship with the agent computing device and selecting the group of computing devices from a subset (e.g., based on a filtering) of one or more of the plurality of insurer computing devices and the plurality of managing general agent computing devices.

The method further includes step 694, with the platform computing device generating a plurality of application data sets by modifying at least one data point of the application data in accordance with an insurer specific requirement (e.g., formatting the at least one data point according to various insurer-specific data formats, creating an application specific header, etc.). As an example, the platform computing device modifies one or more of first data point and a second data point of the application data to produce a first application data set of the plurality of application data sets and utilizes the application data without modification to create a second data application data set of the plurality of application data sets.

In some examples, the generation of multiple application data sets allows for a quote request to be transmitted to a plurality of insurance computing devices and/or a plurality of managing general agent computing devices with one-click (e.g., a singular selection indicated by an agent computing device for a quote request).

As a specific example, a first insurer requires a haul data field and a second insurer requires a cargo field. The platform computing device 20 generates a first application data set that includes a haul data field, which is populated with data indicating “wheat”, and generates a second application data set that includes a cargo data field, which is population with data indicated “wheat”.

As another specific example, a first insurer requires a zip code where a truck is lodged, and a second insurer requires a physical address. The platform computing device 20 generates a first application data set to include the zip code and generates a second application data set to include the physical address, which includes the zip code.

The method further includes step 696, with the platform computing device sends the multiple application data sets to the group of computing devices to solicit a plurality of quote replies for the quote request. In some examples, the platform computing device 20 sends the multiple application data sets to the group of computing devices substantially simultaneously (e. g., different frequency channels, in parallel, etc.).

In some examples, the method includes receiving a plurality of quote responses from the group of computing devices, where each quote reply includes a quote and prospective terms regarding the policy. In some examples, the method includes receiving at least some quote responses from at least some of the group computing devices and communicating the at least some quote responses with the agent computing device. The method can also include receiving a selection of a first quote response of the at least some quote responses and facilitating binding of the policy between the client and an insurer associated with the first quote response.

As a specific example, the plurality of quote replies are consolidated and displayed within a centralized application interface of the BPP network that is accessible in real-time by one or more of the group of computing devices and the agent computing device. In some examples, the centralized application interface provides a comparison of quotes based on at least one of coverage cost, coverage options, risk factors, service information, regulatory information, deductibles, policy terms, and insurer rating.

In some examples, the method includes providing a recommended quote to the agent computing device based on an analysis of the plurality of quote responses. The analysis may include utilizing a machine learning model that was trained on data (e.g., 300-654) associated with one or more of the agent computing device, a managing general agent computing device of the one or more managing general agent computing devices, and an insurer computing device of the one or more insurer computing devices. In some examples, the method includes determining a response by the agent computing device to the recommended quote and updating the machine learning model based on the response.

In some examples, the method includes receiving at least some quote responses from at least some of the group of computing devices, where a quote reply of the at least some quote replies includes a group of policy data points regarding a prospective policy to be associated with the client, generating a sorted list of quotes based on at least one data point of the at least some quote replies, and sending the sorted list of quotes to the agent computing device. The method further includes receiving a selection of the sorted list of quotes associated from the agent computing device and facilitating binding of the policy between the client and an insurer associated with a corresponding one of the at least some of the group of computing devices and the selection.

In some examples, the method further includes producing a plurality of quote responses for selection by the agent computing device based on a one click submission by the agent computing device to initiate sending the quote request to a platform computing device of the one or more platform computing devices

In some examples, the method further includes analyzing the application data to determine a risk profile associated with the client. The risk profile may be based on one or more of historical data, business information, fleet details, driver information, cargo information, geographic areas, and an evaluation of the client's industry sector. In some examples, the risk profile is determined by analyzing one or more of the application data and external data regarding the client (e.g., from a trusted recourse server, from a verification server, etc.). In some examples, the method includes authenticating the agent computing device and when the agent computing device has been authenticated, allowing reception of the quote request.

Note the policy, as referenced in the quote request, may represent the specific insurance coverage or agreement that the client seeks to obtain and that the receipt of the quote request may trigger a series of actions aimed at efficiently, accurately, and securely processing the quote request and facilitating the eventual binding of the policy. The modifications to the data points may be performed to align with the specific requirements (e.g., data format, data type, inclusion of particular data point in a data field (e.g., percentage of cargo type A), a name of the data field, etc.) or preferences of the insurers or agents, thereby enhancing the likelihood of receiving accurate and relevant quote replies.

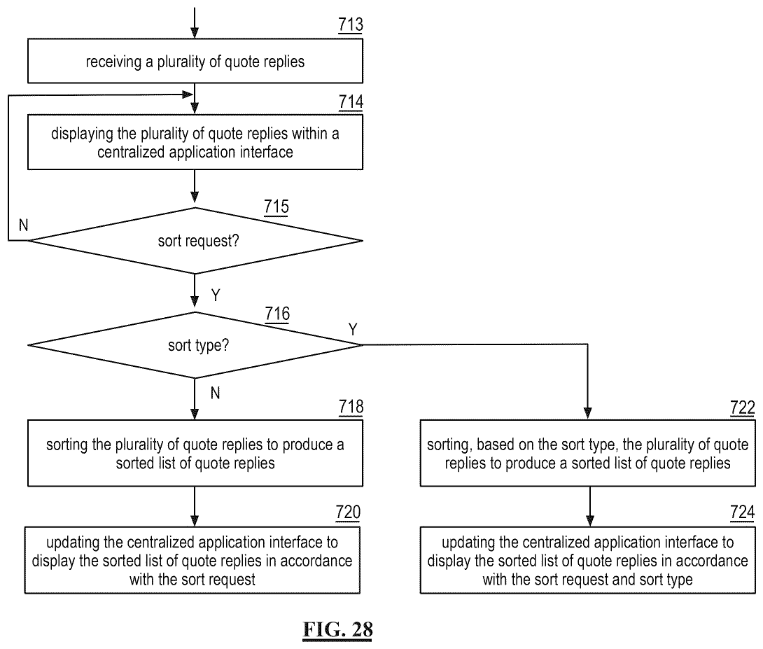

FIG. 28 is a flowchart of an example of a method for execution by a (e.g., one or more) processing module (e.g., of an agent computing device, of a platform computing device, etc.) of the BPP network for sorting and displaying quote responses via a centralized application interface. The method includes step 713, where the processing module receives a plurality of quote replies from one or more insurer computing devices and/or one or more managing general agent computing devices. The method further includes step 714, where the processing module displays the plurality of quote replies within a centralized application interface that is configured to be displayed on a display of an agent computing device. The method further includes step 715, where the processing module determines whether a sort request has been received regarding the plurality of quote replies. Note the sort request may be determined based on one or more of a selection received from a user of the agent computing device, an automatic sort based on a user setting, and a number of quote replies exceeding a threshold.

The method further includes step 716, where the processing module determines whether to apply a sort type to the sort request. The sort type includes one or more of a dynamic sort, a static sort, and a ranked sort. An example of a dynamic sort includes updating the sorted list as additional quote replies are received, updating the sorted list as quote replies are rejected by the agent computing device, and updating the sorted list based on an additional sort request parameter (e.g., a second sort parameter).

An example of a static sort includes not updating the sorted list as additional quote replies are received, and being based on a single sort request parameter (e.g., sort based on column B data values). An example of a ranked sort includes sorted the quote replies based on an automatic ranking function that is based on a plurality of data points (e.g., desired coverage amount, desired term, desired deductible) associated with the quote request and a second plurality of data points (offered coverage amount, offered term, offered deductible) associated with a quote reply. In an example, the automatic ranking function is based on a receiving selection that ranks various data points associated with the quote request as part of a user profile (e.g., an agent profile, a client profile).

When the sort request does not include a sort type, the method includes step 718, where the processing module sorts the plurality of quote replies based on the sort request to produce a sorted list of quote replies. The method further includes step 718, where the processing module updates the centralized application interface to display the sorted list of quote replies on the display of the agent computing device. Note in an alternative embodiment, step 716 is skipped and the method goes from step 714 to step 718.

When the sort request does include a sort type, the method includes step 722, where the processing module sorts the plurality of quote replies based on the sort request and the sort type to produce a sorted list of quote replies. The method further includes step 724, where the processing module updates the centralized application interface to display the sorted list of quote replies on the display of the agent computing device.

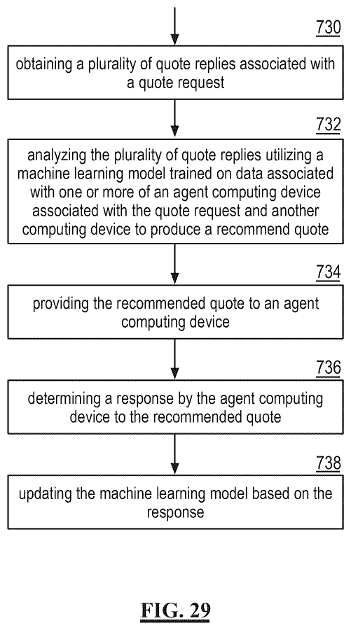

FIG. 29 is a flowchart illustrating an example of a method of updating a machine learning model to provide recommended quotes. The method includes step 730, where a processing module (e.g., of a platform computing device 20) obtains a plurality of quote replies associated with a quote request. For example, the processing module sends the quote request to a plurality of insurer computing devices and receives the plurality of quote replies in response to the quote request.

The method further includes step 732, where the processing module analyzes the plurality of quote replies utilizing a machine learning model trained on data associated with one or more of an agent computing device associated the quote request, and organized entity information of the BPP network to produce a recommend quote.

The method further includes step 734, where the processing module provides the recommended quote to the agent computing device. The method further includes step 736, where the processing module determines a response by the agent computing device to the recommend quote. For example, the response includes one or more of an elapsed time to respond, a favorable response (e.g., selection of the recommended quote), an unfavorable response (e.g., a selection of a quote that was not the recommended quote), a number of actions taken within a centralized application interface after receiving the recommended quote and providing the response.

The method further includes step 738, where the processing module updates the machine learning model based on the response. For example, the processing module updates coefficients of the model to reduce a mean squared error of the model when including the new data associated with the response. As another example, the processing module updates a bias value of the machine learning model based on the response.

FIG. 30 is a flowchart illustration an example of a method of forming an entity pair in a BPP network. The method includes step 750, where a processing module (e.g., of a platform computing device 20) determines whether a first data group associated with an agent computing device compares favorably to first criteria associated with a second computing device. For example, the processing module obtains a risk score (e.g., based on the first data group) associated with the agent computing device and an acceptable risk score range (e.g., the first criteria) associated with an insurer computing device. When the risk score is within the acceptable risk score range, the processing module determines the comparison is favorable.

When the comparison is not favorable, the method loops back to step 750, where the processing module can repeat step 750 with the same computing device or with a different computing device (e.g., a third computing device (e.g., a managing general agent computing device)). When the comparison is favorable, the method includes step 752, where the processing module associates the agent computing device with the second computing device to produce an entity pair. In an example, the entity pair is utilized to determine a computing device of the BPP network to send a quote request via a one click submission.

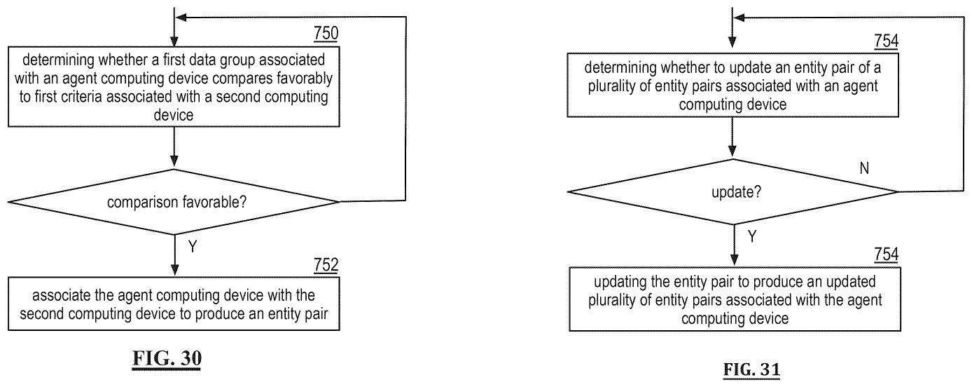

FIG. 31 is a flowchart illustration an example of a method of updating an entity pair in a BPP network. The method includes step 754, where a processing module (e.g., of a platform computing device 20) determines whether to update an entity pair of a plurality of entity pairs associated with an agent computing device. The determining whether to update may be based on one or more of a change (e.g., addition, deletion, modification of first criteria, etc.) of an entity within the BPP network, a time period elapsing (e.g., every 10 minutes), a command, and automatic trigger based on a machine learning algorithm (e.g., that analyze data points associated with the entity pair) output exceeding a threshold.

When the processing module determines not to update the entity pair, the method loops back to step 754, or alternatively, ends. When the processing module determines to update the entity pair, the processing module updates the entity pair to produce an updated plurality of entity pairs. For example, the processing module removes the entity pair from the plurality of entity pairs. As another example, the processing module changes a level associated with an entity pair to a higher level. For example, the processing module changes the entity pair level from a market access gateway level to an appointment level. In an example, the higher entity pair level indicates the entity pair will be involved in a higher number of quote requests.

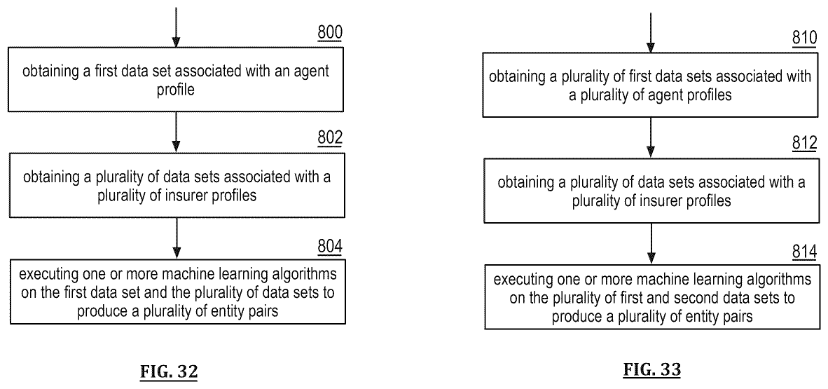

FIG. 32 is a flowchart illustration an example of a method of producing entity pairs in a BPP network. The method includes step 800, where a processing module (e.g., of a platform computing device 20) obtains (e.g., generates, receives, etc.) first data set associated with an agent profile. For example, the processing module retrieves a data record from a data table containing organized agent information 500-1, where the data record is associated with the agent computing device and the organized agent information 500-1 is stored in a BPP database 22.

The method continues with step 802, where the processing module obtains a plurality of data sets associated with a plurality of insurer profiles (e.g., that are associated with insurer computing devices of the BPP network). The method continues with step 804, where the processing module executes one or more machine learning algorithms on the first data set and the plurality of data sets to produce a plurality of entity pairs.

FIG. 33 is a flowchart illustration an example of a method of producing entity pairs in a BPP network. The method includes step 810, where a processing module (e.g., of a platform computing device 20) obtains (e.g., generates, receives, etc.) a plurality of first data sets associated with a plurality of agent profiles. For example, the processing module retrieves a plurality of data records from a data table containing organized agent information 500-1, where the plurality of data records are associated with the plurality of agent computing device and the organized agent information 500-1 is stored in a BPP database 22.

The method continues with step 802, where the processing module obtains a plurality of data sets associated with a plurality of insurer profiles (e.g., that are associated with insurer computing devices of the BPP network). The method continues with step 804, where the processing module executes one or more machine learning algorithms on the plurality of first data sets and the plurality of second data sets to produce a plurality of entity pairs.

Note that the methods of FIGS. 30-33 of producing entity pairs can be performed utilizing any combination of entities of the BPP network. For example, the above methods can be utilized to produce an entity pair between a managing general agent computing device and an insurer computing device, between a client computing device and an agent computing device, between an agent computing device and a managing general agent computing device, etc.

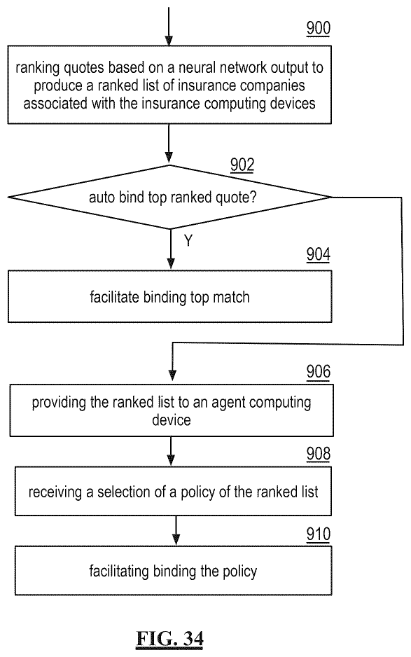

FIG. 34 is a flowchart illustration an example of a method of facilitating binding of a policy in a BPP network. The method includes step 900, where a processing module (e.g., of a platform computing device 20) ranks quote replies based on a neural network output to produce a ranked list of insurance companies associated with a plurality of insurer computing devices. The neural network may include one or more of a feedforward neural network, a convolutional neural network, a recurrent neural network, a gated recurrent unit, an autoencoder, a radial basis function network, a Hopfield network, etc.

The method further includes step 902, where the processing module determines whether to facilitate auto-binding the top ranked quote. When yes, the method includes step 904, where the processing module facilitates binding the top match. For example, the processing module facilitates access to a document transfer portal of the BPP network which allows an agent computing device and an insurer computing device associated with the policy to communicate, transfer, and sign in real-time, documents needed to complete binding the policy. The document transfer portal is displayed on a display of the corresponding computing devices via the centralized application interface of the BPP network.

When the processing module determines not to auto bind the top ranked quote, the method continues with step 906, where the processing module provides the ranked list to an agent computing device (e.g., that sent a quote request associated with the quotes) of the BPP network. The method continues with step 908, where the processing module receives a selection of a policy of the ranked list from an agent computing device. The method continues with step 910, where the processing module facilitates binding the policy between the agent computing device and an insurer computing device (or managing general agent computing device associated with an insurer). For example, the processing module facilitates access (e.g., to both computing devices in real-time) to a document transfer portal of the BPP network which allows an agent computing device and an insurer computing device associated with the policy to communicate, transfer, and sign, documents needed to complete binding the policy. In an example, the document transfer portal is displayed on a display of the corresponding computing devices via the centralized application interface of the BPP network.

In various embodiments, the operational instructions, when executed by the at least one processing module, cause the processing module to perform one or more steps of the methods described herein. In various embodiments, the description of the computing infrastructure (e.g., types, numbers of computing devices, how the computing devices are connected, etc.) and the way it works within the binding policy platform network and the various solutions herein are for demonstration purposes as to one or more specific embodiments. Other forms of computing infrastructure configurations and embodiments could be used together with the various methods and/or solutions described herein.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “one-click” indicates that with one action taken by an agent computing device, a plurality of quote replies can be provided in response to a quote request, where the plurality of quote replies may be ranked or automatically selected, and when automatically selected, a binding policy process can be initiated, up to fulfilled automatically in accordance with one or more agent settings and insurer settings. This improves at least data transfer technology within a BPP network. The one-click process also provides a practical application even if one or more elements of the one-click process include a mathematical expression, law of nature, or abstract idea.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence-i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more platform computing devices of a binding policy platform (BPP) network, the method comprising:
receiving a quote request regarding a policy from an agent computing device of the BPP network, wherein the quote request includes application data associated with the policy and a client;
determining a plurality of entity pairs of the BPP network, wherein each entity pair of the plurality of entity pairs includes the agent computing device and a corresponding computing device of a group of computing devices, and wherein the group of computing devices includes one or more insurer computing devices of the BPP network and one or more managing general agent computing devices of the BPP network;
generating a plurality of application data sets based on a modification of at least one data point of the application data, and an insurer-specific requirement of a plurality of insurer-specific requirements; and
sending the plurality of application data sets to the group of computing devices to solicit a plurality of quote replies for the quote request.

2. The method of claim 1 further comprising:
determining a risk profile associated with the client.

3. The method of claim 2 further comprising:
selecting the group of computing devices from a plurality of computing devices based on the risk profile.

4. The method of claim 3, wherein the selecting the group of computing devices comprises:
determining a plurality of insurer computing devices and a plurality of managing general agent computing devices that are identified as having an appointment relationship with the agent computing device; and
selecting the group of computing devices from one or more of the plurality of insurer computing devices and the plurality of managing general agent computing devices.

5. The method of claim 2, wherein the risk profile includes at least one of:
historical claims data;
business information;
fleet details;
driver information;
cargo information;
geographic areas associated with the client; and
an evaluation of an industry sector associated with the client.

6. The method of claim 1 further comprising:
receiving a plurality of quote replies from the group of computing devices, wherein each quote reply includes a quote and terms regarding the policy from an insurer or managing general agent.

7. The method of claim 6, wherein the plurality of quote replies are consolidated within a centralized application interface of the BPP network that is accessible in real-time by one or more of the group of computing devices and the agent computing device.

8. The method of claim 7, wherein the centralized application interface allows for comparison of quotes based on at least one of:
coverage cost;
coverage options;
risk factors;
service information;
regulatory information;
deductibles;
policy terms; and
insurer rating.

9. The method of claim 1 further comprising:
providing a recommended quote to the agent computing device based on an analysis of the plurality of quote replies.

10. The method of claim 9, wherein the analysis comprises:
utilizing a machine learning model that was trained on data associated with one or more of the agent computing device, a managing general agent computing device of the one or more managing general agent computing devices, and an insurer computing device of the one or more insurer computing devices.

11. The method of claim 10 further comprises:
determining a response by the agent computing device to the recommended quote; and
updating the machine learning model based on the response.

12. The method of claim 1 further comprising:
receiving at least some quote replies from at least some of the group of computing devices, wherein a quote reply of the at least some quote replies includes a group of policy data points regarding a prospective policy to be associated with the client;
generating a sorted list of quotes based on at least one data point of the at least some quote replies; and
sending the sorted list of quotes to the agent computing device.

13. The method of claim 12 further comprising:
receiving a selection of the sorted list of quotes associated from the agent computing device; and
facilitating binding of the policy between the client and an insurer associated with a corresponding one of the at least some of the group of computing devices and the selection.

14. The method of claim 1 further comprises:
producing a ranked list of quote replies from the plurality of quote replies, wherein the ranked list of quote replies is displayed for selection by the agent computing device based on a one click submission by the agent computing device to initiate sending the quote request to a platform computing device of the one or more platform computing devices.

15. The method of claim 1, wherein the plurality of insurer-specific requirements comprises two or more of:
a particular data field;
a particular data format;
a particular name of a data field; and
a particular data point within the data field.

16. The method of claim 1, wherein the generating the plurality of application data sets comprises:
modifying a first data point of the application data to produce a first application data set of the plurality of application data sets; and
utilizing the application data without modification to create a second data application data set of the plurality of application data sets.

17. The method of claim 16 further comprises:
modifying a second data point of the application data to produce the first application data set.

18. The method of claim 1, wherein the determining the plurality of entity pairs comprises:
determining one or more of insurer computing devices and managing general agent computing devices that are identified as having an appointment relationship with the agent computing device; and
selecting the group of computing devices from the one or more of the insurer computing devices and the managing general agent computing devices that have the appointment relationship.

19. The method of claim 1 further comprises:
receiving at least some quote replies from at least some of the group computing devices; and
communicating the at least some quote replies with the agent computing device.

20. The method of claim 19 further comprises:
receiving a selection of a first quote reply of the at least some quote replies; and
facilitating binding of the policy between the client and an insurer associated with the first quote reply.
